(19) United States
(12) Patent Application Publication
(10) Pub. No.: US 2011/0033756 A1
(43) Pub. Date: Feb. 10, 2011

(54) LITHIUM ION SECONDARY BATTERY

(75) Inventor: Kensuke NAKURA, Osaka (JP)

Correspondence Address: MCDERMOTT WILL & EMERY LLP, 600 13TH STREET, NW, WASHINGTON, DC, 20005-3096, US

(73) Assignee: Panasonic Corporation, Osaka (JP)

(21) Appl. No.: 12/904,663

(22) Filed: Oct. 14, 2010

Related U.S. Application Data
(63) Continuation of application No. 11/887,320, filed on Sep. 28, 2007.

(30) Foreign Application Priority Data
Jul. 7, 2005 (JP) 2005-199270

(51) Int. Cl. H01M 10/056; H01M 4/48

(52) U.S. Cl. 429/336; 429/231.3; 429/223; 429/224; 429/231.5; 429/231.6; 429/231.95; 429/342; 429/339

(57) ABSTRACT

The present invention intends to improve the intermittent cycle characteristics in a lithium ion secondary battery including, as a positive electrode active material, a lithium composite oxide mainly composed of nickel or cobalt. The present invention is a lithium ion secondary battery wherein the positive electrode includes active material particles including a lithium composite oxide. The lithium composite oxide is represented by the general formula (1): LiₓM_{1-y}L_{y}O₂ (where 0.85≦x≦0≦y≦0.50, and element M is at least one selected from the group consisting of Ni and Co, and element L is at least one selected from the group consisting of alkaline earth elements, transition metal elements, rare earth elements, Group IIIb elements and Group IVb elements). The surface layer of the active material particles includes element Le being at least one selected from the group consisting of Al, Mn, Ti, Mg, Zr, Nb, Mo, W and Y. The active material particles are surface-treated with a coupling agent.

### TECHNICAL FIELD

The present invention relates to a lithium ion secondary battery with excellent life characteristics.

### BACKGROUND ART

Lithium secondary batteries typical of non-aqueous electrolyte secondary batteries have high electromotive force and high energy density. Because of these features, lithium secondary batteries are now in increasing demand as a main power supply of mobile communication devices and portable electronic devices.

Enhancing reliability of lithium ion secondary batteries has been a crucial technical challenge in development thereof. A lithium composite oxide such as LiₓCoO₂ or LiₓNiO₂ (where x varies depending on charging and discharging of a battery) includes Co⁴⁺ or Ni⁴⁺ with a high valence, which has an excellent reactivity during charging. Because of this, under a high temperature environment, decomposition reaction of electrolyte correlated with a lithium composite oxide is facilitated, and gas is generated in the battery, making it impossible to obtain sufficient cycle characteristics and high temperature storage characteristics.

In order to suppress reaction between an active material and an electrolyte of lithium ion secondary batteries, one proposal suggests that the surface of a positive electrode active material be treated with a coupling agent (Patent Documents 1 to 3). A stable coating film is formed on the surface of active material particles by virtue of the coupling agent, whereby the electrolyte decomposition reaction correlated with a lithium composite oxide is suppressed.

In view of suppressing the reaction between an active material and an electrolyte to improve cycle characteristics and high temperature storage characteristics, and other points, another proposal suggests that various elements be added to the positive electrode active material (Patent Documents 4 to 8).

With respect to LiₓNiO₂, improving water resistance has been a challenge. In light of this, there has been proposed that the surface of LiₓNiO₂ be rendered hydrophobic with a coupling agent to improve the stability of the active material (Patent Document 9).

### Patent Document 1: Japanese Laid-Open Patent Publication Hei

### Patent Document 2: Japanese Laid-Open Patent Publication 2002-367610

### Patent Document 3: Japanese Laid-Open Patent Publication Hei 8-111243

### Patent Document 4: Japanese Laid-Open Patent Publication Hei 11-16566

### Patent Document 5: Japanese Laid-Open Patent Publication 2001-196063

### Patent Document 6: Japanese Laid-Open Patent Publication Hei 7-176302

### Patent Document 7: Japanese Laid-Open Patent Publication Hei 11-40154

### Patent Document 8: Japanese Laid-Open Patent Publication 2004-111076

### Patent Document 9: Japanese Laid-Open Patent Publication 2000-281354

### DISCLOSURE OF THE INVENTION

### Problem to be Solved by the Invention

As described above, many proposals have been made in order to suppress gas generation and improve cycle characteristics and high temperature storage characteristics. However, these techniques have points to be improved as follows.

Many of lithium ion secondary batteries are used in various portable devices. The various portable devices are not always used immediately after the batteries are charged. In many cases, the batteries are left in a charged state for a long period of time and thereafter discharged. The current situation is, however, that the cycle life characteristics of the batteries are generally evaluated under conditions different from such actual conditions for use as described above.

For example, a typical cycle life test is performed under a condition with a short rest (pause) time after charging (for example, rest time: 30 min). In the case where evaluation is performed under such a condition, the cycle life characteristics can be improved to some extent with the above technologies as have been conventionally suggested.

However, assuming the actual conditions for use, in the case where an intermittent cycle (charge and discharge cycle with a long rest time after charging) is repeated, favorable results about the cycle life characteristics have not yet been obtained. For example, it has been found that in the case of a cycle life test with a rest time of 720 minutes, neither one of the above described technologies can provide sufficient life characteristics. In other words, a remaining challenge with respect to the conventional lithium ion secondary batteries is to improve intermittent cycle characteristics.

### Means for Solving the Problem

In view of the above, the present invention intends to improve intermittent cycle characteristics in a lithium ion secondary battery including a lithium composite oxide containing nickel or cobalt as the positive electrode active material.

Specifically, the present invention relates to a lithium ion secondary battery having a chargeable and dischargeable positive electrode, a chargeable and dischargeable negative electrode, and a non-aqueous electrolyte, wherein the positive electrode includes active material particles, the active material particles include a lithium composite oxide, the lithium composite oxide is represented by the general formula (I): LiₓM_{1-y}L_{y}O₂, the general formula (1) satisfies 0.85≦x≦1.25 and 0≦y≦0.50, element M is at least one selected from the group consisting of Ni and Co, element L is at least one selected from the group consisting of alkaline earth elements, transition metal elements, rare earth elements, Group IIIb elements and Group IVb elements, the surface layer of the active material particles includes element Le being at least one selected from the group consisting of Al, Mn, Ti, Mg, Zr, Nb, Mo, W and Y, and the active material particles are surface-treated with a coupling agent.

It is preferable that in the general formula (1), when 0<y, element L includes at least one selected from the group consisting of Al, Mn, Ti, Mg, Zr, Nb, Mo, W and Y as an essential element.

It is preferable that the silane coupling agent forms a silicon compound bonded to the surface of the active material particles through Si—O bonds as a result of the surface treatment.

In one general embodiment of the present, invention, element L and element Le form crystalline structures different from each other. For example, element Le forms an oxide or a lithium-containing oxide having a crystalline structure different from that of the lithium composite oxide.

The amount of the coupling agent is preferably less than or equal to 2 wt % relative to the active material particles.

In the present invention, various silane coupling agents may be used. It is desirable that the silane coupling agent includes at least one selected from the group consisting of an alkoxide group and a chlorine atom, and at least one selected from the group consisting of a mercapto group, an alkyl group and a fluorine atom.

The mean particle size of the active material particles is preferably more than or equal to 10 μm.

In view of achieving further improvement in intermittent cycle characteristics, it is preferable that the non-aqueous electrolyte includes at least one selected from the group consisting of vinylene carbonate, vinyl ethylene carbonate, phosphazene and fluorobenzene.

### EFFECTS OF THE INVENTION

According to the present invention, it is possible to improve intermittent cycle characteristics than ever before in a lithium ion secondary battery including a lithium composite oxide mainly composed of nickel or cobalt (Ni/Co based Li composite oxide) as a positive electrode active material. As for the reason why the intermittent cycle characteristics can be secured, only a phenomenological reason is recognized at present.

It should be noted that simply surface treating active material particles containing a Ni/Co based Li composite oxide with a coupling agent provides only a slight improvement in intermittent cycle characteristics. Similarly, simply including element Le in the surface layer of the active material particles provides only a slight improvement in intermittent cycle characteristics.

However, including element Le in the surface layer of active material particles containing a Ni/Co based Li composite oxide plus surface-treating the active material particles with a coupling agent provides a drastic improvement in intermittent cycle characteristics. This has been confirmed by various experiments.

It is considered that the drastic improvement in intermittent cycle characteristics has relevance to that the peeling-off of the coupling agent is suppressed. The coupling agent is bonded to oxygen present in the surface of the active material particles. It is considered that in the case where element Le is not present in the surface layer of the active material particles, oxygen being bonded to the coupling agent is separated from the active material surface during intermittent cycles. As a result, it is considered that the coupling agent loses a function of suppressing the decomposition reaction of electrolyte.

On the other hand, it is considered that in the case where element Le is present in the surface layer of the active material particles, oxygen is not readily separated from the active material surface because of increased dissociation energy of oxygen. It is considered that this suppresses the peeling off of the coupling agent from the active material surface during intermittent cycles, allowing the function of the coupling agent to be maintained.

It is difficult at present to accurately analyze what form element Le may take in the surface layer of the active material particles. However, it can be confirmed by various methods that element Le is carried on at least part of the surface of the Ni/Co based Li composite oxide, and present in a state of an oxide or a lithium-containing oxide having a crystalline structure different from that of the Ni/Co based Li composite oxide. These methods include element mapping by EPMA (Electron Probe Micro-Analysis), analysis of chemical bonding state by XPS (X-ray Photoelectron Spectroscopy), analysis of surface composition by SIMS (Secondary Ionization Mass Spectroscopy) and the like.

### BRIEF DESCRIPTION OF THE DRAWING

FIG. 1 A vertical sectional view of a cylindrical lithium ion secondary battery according to Example of the present invention.

### BEST MODE FOR CARRYING OUT THE INVENTION

A positive electrode according to the present invention will be hereinafter described. The positive electrode includes active material particles as follows.

The active material particles include a lithium composite oxide mainly composed of nickel or cobalt (Ni/Co based Li composite oxide). Although the form of the lithium composite oxide is not particularly limited, for example, there are cases where the lithium composite oxide is in a state of primary particles and forms the active material particles and where the lithium composite oxide is in a state of secondary particles and forms the active material particles. A plurality of the active material particles may be aggregated to form secondary particles.

Although, a mean particle size of the active material particles or the Ni/Co based Li composite oxide particles is not particularly limited, for example, preferred is 1 to 30 μm, and particularly preferred is 10 to 30 μm. The mean particle size may be measured with a wet laser diffraction type particle size distribution meter manufactured by MICRO TRUCK CO., LTD. In this case, the volume basis 50% value (median value: D₅₀) can be regarded as the mean particle size.

The lithium composite oxide is represented by the general formula (I): LiₓM_{1-y}L_{y}O₂. The general formula (I) satisfies 0.85≦x≦1.25 and 0≦y≦0.50. Element M is at least one selected from the group consisting of Ni and Co. Element L is at least one selected from the group consisting of alkaline earth elements, transition metal elements, rare earth elements, Group IIIb elements and Group IVb elements. Element L provides the lithium composite oxide with effects of improving thermal stability and the like.

It is preferable that in the general formula (I), when 0<y, the lithium composite oxide preferably includes at least one selected from the group consisting of Al, Mn, Ti, Mg, Zr, Nb, Mo, W and Y as element L. These elements may be included in the lithium composite oxide singly or may be included in combination of two or more as element L. Among these, Al is preferred as element L because of its strong bonding strength with oxygen. Further, Mn, Ti and Nb are preferred. Although Ca, Sr, Si, Sn, B, etc. may be included as element L, using these in combination with Al, Mn, Ti, Nb, etc. is desired.

The range of x representing a Li content is increased or decreased in association with charge and discharge of a battery. The range of x in a full discharge state (initial state) may be 0.85≦x≦1.25; however, preferred is 0.93≦x≦1.1.

The range of y representing an element L content may be 0≦y≦0.50; however, preferred is 0<y≦0.50 and particularly preferred is 0.001≦y≦0.35 in light of the balance among the capacity, the cycle characteristics, the thermal stability and the like.

In the case where element L includes Al, the atomic ratio a of Al to the total of Ni, Co and element L is preferably 0.005≦a≦0.1, and particularly preferably 0.01≦a≦0.08.

In the case where element L includes Mn, the atomic ratio b of Mn to the total of Ni, Co and element L is preferably 0.005≦b≦0.5, and particularly preferably 0.01≦b≦0.35.

In the case where element L includes at least one selected from the group consisting of Ti and Nb, the atomic ratio c of Ti and/or Nb to the total of Ni, Co and element L is preferably 0.001≦c≦0.1, and particularly preferably 0.001≦c≦0.08.

The lithium composite oxide represented by the above-described the general formula may be synthesized by baking a starting material having a predetermined metallic element ratio in an oxidizing atmosphere. In the starting material, lithium, nickel (and/or cobalt) and element L are included. The starting material includes an oxide, a hydroxide, an oxyhydroxide, a carbonate, a nitrate, an organic complex salt or the like of each metallic element. These may be used singly or in combination of two or more.

In light of facilitating synthesis of the lithium composite oxide, it is preferable that the starting material includes a solid solution containing a plurality of metallic elements. The solid solution containing a plurality of metallic elements can be formed in any form such as an oxide, a hydroxide, an oxyhydroxide, a carbonate, a nitrate or an organic complex salt. For example, it is preferable to use a solid solution containing Ni and Co, a solid solution containing Ni and element L, a solid solution containing Co and element L, a solid solution containing Ni, Co and element L or the like.

Although the baking temperature of the starting material and the oxygen partial pressure in the oxidizing atmosphere are dependent on the composition of the starting material, the amount of the starting material, synthesizing apparatus and the like, one skilled in the art would select appropriate conditions, as needed.

There may be a case where elements other than Li, Ni, Co and element L get mixed as impurities in an amount within a range in which they are normally included in an industrial starting material; however, this will not significantly affect the effects of the present invention.

The surface layer of the active material particles according to the present invention includes element Le. Herein, element Le is at least one selected from the group consisting of Al, Mn, Ti, Mg, Zr, Nb, Mo, W and Y. The surface layer of the active material particles may include these elements singly or in an optional combination of two or more. The surface layer of the active material particles may contain other elements such as alkaline earth elements, transition metal elements, rare earth elements, Group IIIb elements and Group IVb elements as optional components.

It is preferable that element Le is in a state of an oxide or a lithium-containing oxide, and is deposited, attached or carried on the surface of the lithium composite oxide.

Element L dissolved in the lithium composite oxide and element Le included in the surface layer of the active material particles may or may not contain an element of the same kind. When element L and element Le contain an element of the same kind, these are clearly distinguishable from each other because the crystalline structures etc. thereof are different. Element Le is not dissolved in the lithium composite oxide, but mainly forms an oxide having a crystalline structure different from that of the lithium composite oxide in the surface layer of the active material particles. Element L and element Le are distinguishable by various analytic methods exemplified by EPMA, XPS and SIMS.

Although the range of an atomic ratio z of element Le to the total of Ni, Co and element L contained in the active material particle is not particularly limited, preferred is 0.001≦z≦0.05, and particularly preferred is 0.001≦z≦0.01. When z is too small, the effect of suppressing the peeling-off of a coupling agent during intermittent cycles is not obtained sufficiently. On the other hand, when z is too great, since the surface layer of the active material particles functions as a resistant layer to increase the overvoltage, the intermittent cycle characteristics start to degrade.

There may be a case where element Le in the surface layer is dispersed in the lithium composite oxide, and the concentration of element L in the lithium composite oxide becomes higher in the vicinity of the surface layer than in the interior of the active material particles. Namely, there may be a case where element Le in the surface layer is transformed into element L forming the lithium composite oxide.

Element L originated from element Le having been dispersed in the lithium composite oxide is present in the vicinity of the surface layer, and presumably acts similarly to element Le. However, the amount of element Le dispersed in the lithium composite oxide is as small as negligible, which hardly affects the effects of the present invention.

The lithium composite oxide forming the active material particles may be primary particles or secondary particles formed by aggregation of a plurality of primary particles. Alternatively, a plurality of the active material particles may be aggregated to form secondary particles.

Preferred as a source material of element Le included in the surface layer of the active material particles are a sulfate, a nitrate, a carbonate, a chloride, a hydroxide, an oxide, an alkoxide and the like. These may be used singly or in combination of two or more. Among these, particularly preferred is a sulfate, a nitrate, a chloride or an alkoxide in light of battery performance.

The surface of the active material particles is surface-treated with a coupling agent.

The coupling agent has at least one organic functional group and a plurality of bonding groups in its molecule. The organic functional group has various hydrocarbon skeletons. The bonding groups give hydroxyl groups each directly bonded to a metallic atom (for example, Si—OH, Ti—OH or Al—OH) through hydrolysis. A silane coupling agent has in its molecular, for example, an organic functional group such as an alkyl group, a mercaptopropyl group or a trifluoropropyl group, and bonding groups such as alkoxy groups or chlorine atoms that give silanol groups (Si—OH) through hydrolysis.

The “treating with a coupling agent” as used herein means to allow hydroxyl groups (OH groups) present in the surface of the active material particles or the lithium composite oxide to react with the bonding groups in the coupling agent. For example, when the bonding groups are alkoxy groups (OR groups: R=alkyl group), alcohol dissociation reaction proceeds between the alkoxy groups and the hydroxyl groups; and when the bonding groups are chlorine atoms (Cl atoms), the elimination reaction of hydrogen chloride (HCl) proceeds between the chlorine atoms and the hydroxyl groups.

Whether treated with a coupling agent or not can be confirmed by the formation of X—O—Si bond (where X is the surface of the active material particles or the lithium composite oxide), X—O—Ti bond, X—O—Al bond or the like. When the lithium composite oxide includes Si, Ti, Al, etc. as element L, the Si, Ti and Al forming the lithium composite oxide are distinguishable from the Si, Ti and Al originated from the coupling agent because of the difference in structure.

Usable as the coupling agent are, for example, a silane coupling agent, an aluminate based coupling agent and titanate based coupling agent. These may be used singly or in combination of two or more. Among these, it is preferable to use a silane coupling agent in view of its capabilities of coating the surface of the active material particles with an inorganic polymer having a skeleton of siloxane bonds, and suppressing side reaction. Namely, it is preferable that the active material particles carry a silicon compound as a result of the surface treatment.

Considering the reactivity with the hydroxyl groups in the surface of the active material particles, it is preferable that the silane coupling agent has at least one selected from the group consisting of an alkoxy group and a chlorine atom as the bonding group. Moreover, in view of suppressing side reaction with the electrolyte, it is preferable that the silane coupling agent has at least one selected from the group consisting of a mercapto group, an alkyl group and a fluorine atom.

The amount of the coupling agent to be added to the active material particles is preferably less than or equal to 2 wt % relative to the active material particles, and more preferably 0.05 to 1.5 wt %. When the adding amount of the coupling agent exceeds 2 wt %, the surface of the active material is excessively coated with the coupling agent that does not contribute to the reaction, and consequently the cycle characteristics may be degraded.

Next, an example of a method of producing the positive electrode will be described.

### (i) First Step

A lithium composite oxide represented by the general formula (I): LiₓM_{1-y}L_{y}O₂ is prepared. The method of preparing the lithium composite oxide is not particularly limited. For example, the lithium composite oxide may be synthesized by baking a starting material having a predetermined metallic element ratio in an oxidizing atmosphere. The baking temperature, the oxygen partial pressure in the oxidizing atmosphere and the like are selected as needed, depending on the composition of the starting material, the amount of the starting material, synthesizing apparatus, etc.

### (ii) Second Step

The lithium composite oxide thus prepared is allowed to carry a source material of element Le (at least one selected from the group consisting of Al, Mn, Ti, Mg, Zr, Nb, Mo, W and Y). In this case, although the mean particle size of the lithium composite oxide is not particularly limited, 1 to 30 μm is preferred. Value z (the atomic ratio of element Le to the total of Ni, Co and element L) can be usually determined from the amount of element Le contained in the source material used in this step relative to that of the lithium composite oxide.

For the source material of element Le, a sulfate, a nitrate, a carbonate, a chloride, a hydroxide, an oxide, an alkoxide and the like including element Le are used. These may be used singly or in combination of two or more. Among these it is particularly preferable to use a sulfate, a nitrate, a chloride or an alkoxide in light of battery performance. The method of allowing the source material of element Le to be carried on the lithium composite oxide is not particularly limited. For example, it is preferable to dissolve or disperse the source material of element Le in a liquid component to prepare solution or dispersion, subsequently mix the solution or the dispersion with the lithium composite oxide, and then remove the liquid component.

Although the liquid component in which the source material of element Le is dissolved or dispersed is not particularly limited, ketones such as acetone, methyl ethyl ketone (MEK), ethers such as tetrahydrofuran (THF), alcohols such as ethanol, and other organic solvents are preferred. Alkaline water of pH 10 to 14 may be preferably used.

When introducing the lithium composite oxide to the solution or the dispersion thus obtained and stirring it, the temperature of the solution or the dispersion is not particularly limited. However, in view of workability and production costs, the temperature is preferably controlled to 20 to 40° C. Although the stirring time is not particularly limited, stirring for as long as 3 hours, for example, is satisfactory. Although the method of removing the liquid component is not particularly limited, drying at a temperature of approximately 100° C. for about 2 hours, for example, is satisfactory.

(iii) Third Step

The lithium composite oxide carrying element Le on the surface thereof is baked at 650 to 750° C. for 2 to 24 hours, preferably approximately 6 hours under an oxygen atmosphere. Herein, the pressure of the oxygen atmosphere is preferably 101 to 50 KPa. By this baking, element Le is transformed into an oxide having a crystalline structure different from that of the lithium composite oxide.

### (iv) Fourth Step

The active material particles thus obtained are surface-treated with a coupling agent. The method of surface-treating is not particularly limited. For example, the coupling agent is merely added to the active material particles. However, in view of diffusing the coupling agent through the whole active material particles, adding the coupling agent to a positive electrode material mixture paste is desirable. For example, a positive electrode material mixture including the active material particles, a conductive agent and a binder is dispersed in a liquid component to prepare a positive electrode material mixture paste, and then a coupling agent is added thereto, followed by stirring it.

Although the liquid component into which the positive electrode material mixture is dispersed is not particularly limited, ketones such as acetone, methyl ethyl ketone (MEK), ethers such as tetrahydrofuran (THF), alcohols such as ethanol, N-methyl-2-pyrrolidone (NMP) and the like are preferred. Alkaline water of pH 10 to 14 may be preferably used.

The temperature of the paste during stirring after the coupling agent is introduced thereto is preferably controlled to 20 to 40° C. Although the stirring time is not particularly limited, stirring for as long as 15 minutes, for example, is satisfactory.

The positive electrode material mixture paste thus obtained is applied onto a positive electrode core material (positive electrode current collector) and then dried, whereby a positive electrode including active material particles surface-treated with a coupling agent is obtained. Although the drying temperature and time after the paste is applied onto the positive electrode core material are not particularly limited, drying at a temperature of approximately 100° C. for about 10 minutes, for example, is satisfactory.

For the binder to be included in the positive electrode material mixture, either one of a thermoplastic resin and a thermosetting resin may be used; however, a thermoplastic resin is preferred. Examples of the thermoplastic resin include polyethylene, polypropylene, polytetrafluoroethylene (PTFE), polyvinylidene fluoride (PVDF), styrene butadiene rubber, tetrafluoroethylene-hexafluoropropylene copolymer (FEP), tetrafluoroethylene-perfluoroalkyl vinyl ether copolymer (PFA), vinylidene fluoride-hexafluoropropylene copolymer, vinylidene fluoride-chlorotrifluoroethylene copolymer, ethylene-tetrafluoroethylene copolymer (ETFE), polychlorotrifluoroethylene (PCTFE), vinylidene fluoride-pentafluoropropylene copolymer, propylene-tetrafluoroethylene copolymer, ethylene-chlorotrifluoroethylene copolymer (ECTFE), vinylidene fluoride-hexafluoropropylene-tetrafluoroethylene copolymer, vinylidene fluoride-perfluoro methyl vinyl ether-tetrafluoroethylene copolymer, ethylene-acrylic acid copolymer, ethylene-methacrylic acid copolymer, ethylene-methyl acrylate copolymer, and ethylene-methyl methacrylate copolymer. These may be used singly or in combination of two or more. These may be a crosslinked product by Na ions etc.

The conductive material to be included in the positive electrode material mixture may be any one as long as it is an electron conductive material that is chemically stable in a battery. For example, graphite such as natural graphite (scale-shaped graphite etc.) and artificial graphite; carbon blacks such as acetylene black, Ketjen Black, channel black, furnace black, lampblack, and thermal black; conductive fibers such as carbon fibers and metal fibers; powders of metal such as aluminum; conductive whiskers such as zinc oxide and potassium titanate; conductive metal oxides such as titanium oxide; organic conductive materials such as polyphenylene derivatives; and fluorinated carbons and the like may be used. These may be used singly or in combination of two or more. Although the adding amount of the conductive material is not particularly limited, preferred is 1 to 50 wt % relative to the active material particles included in the positive electrode material mixture, more preferred is 1 to 30 wt % and particularly preferred is 2 to 15 wt %.

The positive electrode core material (positive electrode current collector) may be any one as long as it is an electron conductive material that is chemically stable in a battery. For example, foil or sheet made of aluminum, stainless steel, nickel, titanium, carbon, a conductive resin or the like may be used. In particular, aluminum foil, aluminum alloy foil or the like is preferred. On the surface of the foil or sheet, a layer of carbon or titanium may be provided or an oxide layer may be formed. In addition, the surface of the foil or sheet may be made rough. A net, a punched sheet, a lath, a porous material, a foam, a molded article formed by fiber bundle or the like may also be used. Although the thickness of the positive electrode core material is not particularly limited, for example, it is within a range of 1 to 500 μm.

Other components other than the positive electrode of the lithium ion secondary battery of the present invention will be hereinafter described. However, since the lithium ion secondary battery of the present invention has its feature in that it includes the positive electrode as described above, no particular limitation is imposed on other components. Therefore, the present invention is not limited by the following description.

For the lithium chargeable and dischargeable negative electrode, for example, one that comprises a negative electrode core material carrying a negative electrode material mixture including a negative electrode active material and a binder and optionally including a conductive material and a thickening agent may be used. Such a negative electrode may be fabricated in the same manner as in the positive electrode.

The negative electrode active material may be a material capable of electrochemically charging and discharging lithium. For example, graphite, non-graphitizable carbon materials, lithium alloys, metal oxides or the like may be used. Particularly preferred among lithium alloys is an alloy containing at least one selected from the group consisting of silicon, tin, aluminum, zinc and magnesium. Preferred among metal oxides are an oxide containing silicon and an oxide containing tin, which are more preferred if hybridized with a carbon material. Although the mean particle size of the negative electrode active material is not particularly limited, 1 to 30 μm is preferred.

For the binder to be included in the negative electrode material mixture, either one of a thermoplastic resin and a thermosetting resin may be used; however, a thermoplastic resin is preferred. Examples of the thermoplastic resin include polyethylene, polypropylene, polytetrafluoroethylene (PTFE), polyvinylidene fluoride (PVDF), styrene butadiene rubber, tetrafluoroethylene-hexafluoropropylene copolymer (FEP), tetrafluoroethylene-perfluoroalkyl vinyl ether copolymer (PFA), vinylidene fluoride-hexafluoropropylene copolymer, vinylidene fluoride-chlorotrifluoroethylene copolymer, ethylene-tetrafluoroethylene copolymer (ETFE), polychlorotrifluoroethylene (PCTFE), vinylidene fluoride-pentafluoropropylene copolymer, propylene-tetrafluoroethylene copolymer, ethylene-chlorotrifluoroethylene copolymer (ECTFE), vinylidene fluoride-hexafluoropropylene-tetrafluoroethylene copolymer, vinylidene fluoride-perfluoro methyl vinyl ether-tetrafluoroethylene copolymer, ethylene-acrylic acid copolymer, ethylene-methacrylic acid copolymer, ethylene-methyl acrylate copolymer, and ethylene-methyl methacrylate copolymer. These may be used singly or in combination of two or more. These may be a crosslinked product by Na ions etc.

The conductive material to be included in the negative electrode material mixture may be any material as long as it is an electron conductive material that is chemically stable in a battery. Examples of the conductive material include graphite such as natural graphite (scale-shaped graphite etc.) and artificial graphite, carbon blacks such as acetylene black, Ketjen Black, channel black, furnace black, lampblack, and thermal black; conductive fibers such as carbon fibers and metal fibers; powders of metal such as cupper or nickel; and organic conductive materials such as polyphenylene derivatives. These may be used singly or in combination of two or more. Although the adding amount of the conductive material is not particularly limited, preferred is 1 to 30 wt %, and more preferred is 1 to 10 wt % relative to the active material particles included in the negative electrode material mixture.

The negative electrode core material (negative electrode current collector) may be any one as long as it is an electron conductive material that is chemically stable in a battery. For example, foil or sheet made of stainless steel, nickel, cupper, titanium, carbon, a conductive resin or the like may be used. In particular, cupper or a cupper alloy is preferred. On the surface of the foil or sheet, a layer of carbon, titanium, nickel, etc. may be provided or an oxide layer may be formed. In addition, the surface of the foil or sheet may be made rough. A net, a punched sheet, a lath, a porous material, a foam, a molded article formed by fiber bundle or the like may also be used. Although the thickness of the negative electrode core material is not particularly limited, for example, it is within a range of 1 to 500 μm.

For the non-aqueous electrolyte, a non-aqueous solvent with a lithium salt dissolved therein is preferably used.

Examples of the non-aqueous solvent include cyclic carbonates such as ethylene carbonate (EC), propylene carbonate (PC) and butylene carbonate (BC); chain carbonates such as dimethyl carbonate (DMC), diethyl carbonate (DEC), ethyl methyl carbonate (EMC) and dipropyl carbonate (DPC); aliphatic carboxylic acid esters such as methyl formate, methyl acetate, methyl propionate and ethyl propionate; lactones such as γ-butyrolactone and γ-valerolactone; chain esters such as 1,2-dimethoxyethane (DME), 1,2-diethoxyethane (DEE) and ethoxymethoxyethane (EME); cyclic ethers such as tetrahydrofuran and 2-methyltetrahydrofuran; dimethylsulfoxide, 1,3-dioxolane, formamide, acetamide, dimethylformamide, dioxolane, acetonitrile, propylnitrile, nitromethane, ethyl monoglyme, phosphoric acid triester, trimethoxymethane, dioxolane derivatives, sulfolane, methyl sulfolane, 1,3-dimethyl-2-imidazolidinone, 3-methyl-2-oxazolidinone, propylene carbonate derivatives, tetrahydrofuran derivatives, ethyl ether, 1,3-propane sultone, anisole, dimethylsulfoxide and N-methyl-2-pyrrolidone. These may be used singly or in combination of two or more. Preferred among these is a mixture solvent of a cyclic carbonate and a chain carbonate, or a mixture solvent of a cyclic carbonate, a chain carbonate and an aliphatic carboxylic acid ester.

Examples of the lithium salt to be dissolved in the non-aqueous solvent include LiClO₄, LiBF₄, LiPF₆, LiAlCl₄, LiSbF₆, LiSCN, LiCl, LiCF₃SO₃, LiCF₃CO₂, Li(CF₃SO₂)₂, LiASF₆, LiN(CF₃SO₂)₂, LiB₁₀Cl₁₀, lithium lower aliphatic carboxylate, LiCl, LiBr, LiI, chloroborane lithium, lithium tetraphenylborate and lithium imide salts. These may be used singly or in combination of two or more; however, it is preferable to use at least LiPF₆. Although the dissolving amount of the lithium salt in the non-aqueous solvent is not particularly limited, the concentration of lithium salt is preferably 0.2 to 2 mol/L and more preferably 0.5 to 1.5 mol/L.

To the non-aqueous electrolyte, various additives may be added for the purpose of improving charge and discharge characteristics of a battery. Examples of the additives include triethyl phosphate, triethanolamine, cyclic ethers, ethylenediamine, n-glyme, pyridine, hexaphosphoric triamide, nitrobenzene derivatives, crown esters, quaternary ammonium salts and ethylene glycol dialkyl ether.

In view of improving intermittent cycle characteristics, it is preferable that at least one selected from the group consisting of vinylene carbonate, vinyl ethylene carbonate, phosphazene and fluorobenzene is added to the non-aqueous electrolyte. An appropriate content of these additives is 0.5 to 10 wt % relative to the non-aqueous electrolyte.

It is necessary to interpose a separator between the positive electrode and the negative electrode.

For the separator, an electrically-insulating microporous thin film having high ion permeability and a predetermined mechanical strength is preferably used. It is preferable that the microporous thin film has a function that closes pores at a predetermined temperature or higher to increase resistance. As a material for the microporous thin film, a polyolefin such as polypropylene or polyethylene being excellent in resistance to organic solvent and having hydrophobicity is preferably used. Sheet, nonwoven fabric or woven fabric made of glass fibers or the like is also used. The pore size of the separator is, for example, 0.01 to 1 μm. The thickness of the separator is typically 10 to 300 μm. The porosity of the separator is typically 30 to 80%.

A polymer electrolyte comprising a non-aqueous electrolyte and a polymer material holding the same may be used as the separator in combination with the positive electrode or the negative electrode. The polymer material may be any material as long as it can retain the non-aqueous electrolyte; however, a copolymer of vinylidene fluoride and hexafluoropropylene is particularly preferred.

Next, the present invention will be specifically described with reference to Examples; however, the present invention is not limited to the following Examples.

### Example 1

### Battery 1A-2

### (1) Synthesis of Lithium Composite Oxide

Nickel sulfate, cobalt sulfate and aluminum sulfate were mixed so that the molar ratio of Ni atom, Co atom and Al atom was 80:15:5. To 10 L of water, 3.2 kg of the mixture thus obtained was dissolved to prepare a starting material solution. To the starting material solution, 400 g of sodium hydroxide was added to form a precipitate. The precipitate was washed with water sufficiently, and then dried to yield a coprecipitated hydroxide.

To 3 kg of the Ni—Co—Al coprecipitated hydroxide thus obtained, 784 g of lithium hydroxide was added and mixed, and then the mixture was baked for 10 hours at a synthesizing temperature of 750° C. in an atmosphere with an oxygen partial pressure of 0.5 atm. As a result, a Ni/Co based Li composite oxide containing Al as element L (LiNi_{0.8}Co_{0.15}Al_{0.05}O₂) was obtained.

### (2) Synthesis of Active Material Particles

<i> First Step

Into a solution of niobium chloride dissolved in 10 L of ethanol, 2 kg of the lithium composite oxide thus synthesized was dispersed. The amount of the niobium chloride used was 0.5 mol % relative to the lithium composite oxide (namely, 0.5 mol % relative to the total of Ni, Co and Al). The ethanol solution with the lithium composite oxide dispersed therein was stirred at 25° C. for 3 hours. Thereafter the solution was filtered and a solid matter obtained by filtration was dried at 100° C. for 2 hours. As a result, a lithium composite oxide carrying niobium (Nb) on the surface thereof as element Le was obtained.

<ii> Second Step

The powder after drying was subjected to pre-baking at 300° C. for 6 hours under a dry air atmosphere (humidity: 19%, pressure: 101 KPa).

Subsequently, the powder after pre-baking was subjected to final baking at 650° C. for 6 hours under an oxygen 100% atmosphere (pressure: 101 KPa).

Finally, the powder after final baking was annealed at 400° C. for 4 hours under an oxygen 100% atmosphere (pressure: 101 KPa).

As a result of this baking, active material particles comprising a lithium composite oxide and a surface layer containing Nb were obtained. The presence of Nb in the surface layer was confirmed by XPS, EPMA, ICP emission spectrometry or the like. In the following Examples, the presence of element Le in the active material particles was similarly confirmed by XPS, EPMA, ICP emission spectrometry or the like. In the following Examples, the presence of element Le in the surface layer of the active material particles was similarly confirmed by XPS, EPMA, ICP emission spectrometry or the like.

### (3) Fabrication of Positive Electrode

A positive electrode material mixture paste was prepared by stirring 1 kg of the active material particles thus obtained (mean particle size: 12 μm) together with 0.5 kg of PVDF #1320 (N-methyl-2-pyrrolidone (NMP) solution with a solid content of 12 wt %) manufactured by KUREHA CORPORATION, 40 g of acetylene black, 10 g of 3-mercaptopropyltrimethoxysilane (silane coupling agent: KBM-803 manufactured by Shin-Etsu Chemical Co., Ltd.) and an appropriate amount of NMP at 30° C. for 30 minutes with a double arm kneader. This paste was applied onto both faces of a 20 μm thick aluminum foil (positive electrode core material), subsequently dried at 120° C. for 15 minutes, and then rolled until the total thickness reached 160 μm. Thereafter, the electrode plate thus obtained was slit into a width that could be inserted into a cylindrical battery case of size 18650, whereby a positive electrode was obtained.

### (4) Fabrication of Negative Electrode

A negative electrode material mixture paste was prepared by stirring 3 kg of artificial graphite together with 200 g of BM-400B manufactured by ZEON Corporation (dispersion of modified styrene-butadiene rubber with a solid content of 40 wt %), 50 g of carboxymethyl cellulose (CMC) and a proper amount of water with a double arm kneader. This paste was applied onto both faces of a 12 μm thick copper foil (negative electrode core material), subsequently dried, and then rolled until the total thickness reached 160 μm. Thereafter, the electrode plate thus obtained was slit into a width that could be inserted into a cylindrical battery case size 18650, whereby a negative electrode was obtained.

### (5) Preparation of Non-Aqueous Electrolyte

In a mixture solvent of ethylene carbonate and methyl ethyl carbonate in a volume ratio of 10:30, 2 wt % vinylene carbonate, 2 wt % vinylethylene carbonate, 5 wt % fluorobenzene and 5 wt % phosphazene were added. In the solution thus obtained, LiPF₆ was dissolved at a concentration of 1.5 mol/L, whereby a non-aqueous electrolyte was obtained.

### (6) Assembly of Battery

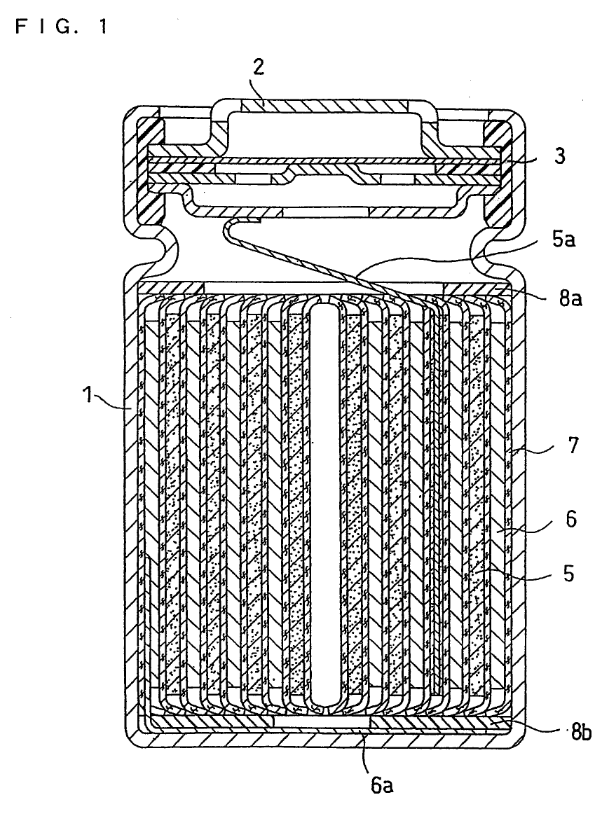

As shown in FIG. 1, a positive electrode 5 and a negative electrode 6 were wound with a separator 7 interposed therebetween to give a spiral-shaped electrode assembly. For the separator 7, composite film of polyethylene and polypropylene (2300 manufactured by Celgard Inc., thickness: 25 μm) was used.

To the positive electrode 5 and the negative electrode 6, a positive electrode lead 5a and a negative electrode lead 6a made of nickel were attached, respectively. An upper insulating plate 8a and a lower insulating plate 8b were disposed on the upper face and the lower face of this electrode assembly, respectively, and then the whole was inserted into a battery case 1. Subsequently, 5 g of non-aqueous electrolyte was injected into the battery case 1.

Thereafter, a sealing plate 2 with a sealing gasket 3 disposed on the circumference thereof was brought into electrical conduction with the positive electrode lead 5a, and then the opening of the battery case 1 was sealed with the sealing plate 2. In such a manner, a cylindrical lithium ion secondary battery of size 18650 was obtained. This is referred to as Example Battery 1A-2.

### <<Battery 1A-1>>

As Comparative Example, Battery 1A-1 was fabricated in the same manner as in Battery 1A-2 except that Nb was not carried as element Le on the Ni/Co based Li composite oxide.

### <<Battery 1A-3>>

Battery 1A-3 was fabricated in the same manner as in Battery 1A-2 except that the amount of the niobium chloride to be dissolved in 10 L of ethanol was changed to 1.0 mol % relative to the Ni/Co based Li composite oxide (namely, 1.0 mol % relative to the total of Ni, Co and Al).

### <<Battery 1A-4>>

In place of the ethanol solution of niobium chloride, 2 kg of Ni/Co based Li composite oxide was dispersed in 1 L of pH 13 aqueous sodium hydroxide solution. In the dispersion thus obtained, an aqueous solution of 0.5 mol % manganese (Mn) sulfate relative to the Ni/Co based Li composite oxide dissolved in 100 g of distilled water was dropped for the duration of 10 minutes, and then stirred at 100° C. for 3 hours. Battery 1A-4 was fabricated in the same manner as in Battery 1A-2 except the above.

### <<Battery 1A-5>>

Battery 1A-5 was fabricated in the same manner as in Battery 1A-4 except that the amount of the manganese sulfate to be dissolved in 100 g of distilled water was changed to 1.0 mol % relative to the Ni/Co based Li composite oxide.

### <<Battery 1A-6>>

In place of the ethanol solution of niobium chloride, 2 kg of Ni/Co based Li composite oxide was dispersed in 1 L of pH 13 aqueous sodium hydroxide solution. In the dispersion thus obtained, an aqueous solution of 0.5 mol % titanium (Ti) nitrate relative to the Ni/Co based Li composite oxide dissolved in 100 g of distilled water was dropped for the duration of 10 minutes, and then stirred at 100° C. for 3 hours. Battery 1A-6 was fabricated in the same manner as in Battery 1A-2 except the above.

### <<Battery 1A-7>>

Battery 1A-7 was fabricated in the same manner as in Battery 1A-6 except that the amount of the titanium nitrate to be dissolved in 100 g of distilled water was changed to 1.0 mol % relative to the Ni/Co based Li composite oxide.

### <<Battery 1A-8>>

In place of the ethanol solution of niobium chloride, 2 kg of Ni/Co based Li composite oxide was dispersed in 1 L of pH 13 aqueous sodium hydroxide solution. In the dispersion thus obtained, an aqueous solution of 0.5 mol % magnesium (Mg) acetate relative to the Ni/Co based Li composite oxide dissolved in 100 g of distilled water was dropped for the duration of 10 minutes, and then stirred at 100° C. for 3 hours. Battery 1A-8 was fabricated in the same manner as in Battery 1A-2 except the above.

### <<Battery 1A-9>>

Battery 1A-9 was fabricated in the same manner as in Battery 1A-8 except that the amount of the magnesium acetate to be dissolved in 100 g of distilled water was changed to 1.0 mol % relative to the Ni/Co based Li composite oxide.

### <<Battery 1A-10>>

In 10 L of butanol, 0.5 mol % zirconium (Zr) tetra-n-butoxide relative to the Ni/Co based Li composite oxide was dissolved. Battery 1A-10 was fabricated in the same manner as in Battery 1A-2 except that the solution thus obtained was used in place of the ethanol solution of niobium chloride.

### <<Battery 1A-11>>

Battery 1A-11 was fabricated in the same manner as in Battery 1A-10 except that the amount of the zirconium tetra-n-butoxide to be dissolved in 10 L of butanol was changed to 1.0 mol % relative to the Ni/Co based Li composite oxide.

### <<Battery 1A-12>>

In 10 L of isopropanol, 0.5 mol % aluminum (Al) triisopropoxide relative to the Ni/Co based Li composite oxide was dissolved. Battery 1A-12 was fabricated in the same manner as in Battery 1A-2 except that the solution thus obtained was used in place of the ethanol solution of niobium chloride.

### <<Battery 1A-13>>

Battery 1A-13 was fabricated in the same manner as in Battery 1A-12 except that the amount of the aluminum triisopropoxide to be dissolved in 10 L of isopropanol was changed to 1.0 mol % relative to the Ni/Co based Li composite oxide.

### <<Battery 1A-14>>

In place of the ethanol solution of niobium chloride, 2 kg of Ni/Co based Li composite oxide was dispersed in 1 L of pH 13 aqueous sodium hydroxide solution. In the dispersion thus obtained, an aqueous solution of 0.5 mol % disodium molybdate (Mo) dihydrate relative to the Ni/Co based Li composite oxide dissolved in 100 g of distilled water was dropped for the duration of 10 minutes, and then stirred at 100° C. for 3 hours. Battery 1A-14 was fabricated in the same manner as in Battery 1A-2 except the above.

### <<Battery 1A-15>>

Battery 1A-15 was fabricated in the same manner as in Battery 1A-14 except that the amount of the disodium molybdate dihydrate to be dissolved in 100 g of distilled water was changed to 1.0 mol relative to the Ni/Co based Li composite oxide.

### <<Battery 1A-16>>

In place of the ethanol solution of niobium chloride, 2 kg of Ni/Co based Li composite oxide was dispersed in 1 L of pH 13 aqueous sodium hydroxide solution. In the dispersion thus obtained, an aqueous solution of 0.5 mol % sodium tungstate (W) relative to the Ni/Co based Li composite oxide dissolved in 100 g of distilled water was dropped for the duration of 10 minutes, and then stirred at 100° C. for 3 hours. Battery 1A-16 was fabricated in the same manner as in Battery 1A-2 except the above.

### <<Battery 1A-17>>

Battery 1A-17 was fabricated in the same manner as in Battery 1A-16 except that the amount of the sodium tungstate to be dissolved in 100 g of distilled water was changed to 1.0 mol % relative to the Ni/Co based Li composite oxide.

### <<Battery 1A-18>>

In place of the ethanol solution of niobium chloride, 2 kg of Ni/Co based Li composite oxide was dispersed in 1 L of pH 13 aqueous sodium hydroxide solution. In the dispersion thus obtained, an aqueous solution of 0.5 mol % yttrium (Y) nitrate relative to the Ni/Co based Li composite oxide dissolved in 100 g of distilled water was dropped for the duration of 10 minutes, and then stirred at 100° C. for 3 hours. Battery 1A-18 was fabricated in the same manner as in Battery 1A-2 except the above.

### <<Battery 1A-19>>

Battery 1A-19 was fabricated in the same manner as in Battery 1A-18 except that the amount of the yttrium nitrate to be dissolved in 100 g of distilled water was changed to 1.0 mol % relative to the Ni/Co based Li composite oxide.

### <<Battery 1A-21>>

Battery 1A-21 was fabricated in the same manner as in Battery 1A-1 except that the amount of 3-mercaptopropyltrimethoxysilane (silane coupling agent) to be added to the positive electrode material mixture paste was changed to 25 g per 1 kg of active material particles.

### <<Batteries 1A-22 to 1A-39>>

Batteries 1A-22 to 1A-39 were fabricated in the same manner as in Batteries 1A-2 to 1A-19 except that the amount of 3-mercaptopropyltrimethoxysilane (silane coupling agent) to be added to the positive electrode material mixture paste was changed to 25 g per 1 kg of active material particles.

### [Evaluation 1]

### (Intermittent Cycle Characteristics)

Each battery was subjected to preliminary charge and discharge twice, and then stored for two days under an environment of 40° C. Thereafter, each battery was subjected to repeated cycles of the following two patterns. The design capacity of the battery was 1 CmAh.

### First Pattern (Normal Cycle Test)

(1) Constant current charge (45° C.): 0.7 CmA (cut-off voltage 4.2 V)

(2) Constant voltage charge (45° C.): 4.2 V (cut-off current 0.05 CmA)

(3) Charge rest (45° C.): 30 min

(4) Constant current discharge (45° C.): 1 CmA (cut-off voltage 3V)

(5) Discharge rest (45° C.): 30 min

### The Second Pattern (Intermittent Cycle Test)

(1) Constant current charge (45° C.): 0.7 CmA (cut-off voltage 4.2 V)

(2) Constant voltage charge (45° C.): 4.2 V (cut-off current 0.05 CmA)

(3) Charge rest (45° C.): 720 min

(4) Constant current discharge (45° C.): 1 CmA (cut-off voltage 3 V)

(5) Discharge rest (45° C.): 720 min

The discharge capacities after 500 cycles obtained in the first and second patterns are show in Table 1A.

TABLE 1A
Lithium composite oxide: LiNi_{0.80}Co_{0.15}Al_{0.05}O₂

| | | | | | | Intermittent cycle | |
|---|---|---|---|---|---|---|---|
| | | | | | | characteristics | |
| | | | | | | Capacity after 500 | |
| | | | | | | cycles | |
| | | Coupling agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 1A | 1 | 3-mercapto- | 1.0 | Nil | — | 2182 | 720 |
| | 2 | propyl- | | Nb | 0.5 | 2180 | 2100 |
| | 3 | trimethoxy- | | | 1.0 | 2005 | 1992 |
| | 4 | silane | | Mn | 0.5 | 2185 | 2105 |
| | 5 | | | | 1.0 | 2002 | 1990 |
| | 6 | | | Ti | 0.5 | 2182 | 2100 |
| | 7 | | | | 1.0 | 2004 | 1994 |
| | 8 | | | Mg | 0.5 | 2184 | 2110 |
| | 9 | | | | 1.0 | 2005 | 1992 |
| | 10 | | | Zr | 0.5 | 2185 | 2105 |
| | 11 | | | | 1.0 | 2002 | 1994 |
| | 12 | | | Al | 0.5 | 2180 | 2107 |
| | 13 | | | | 1.0 | 2005 | 1995 |
| | 14 | | | Mo | 0.5 | 2180 | 2108 |
| | 15 | | | | 1.0 | 2004 | 1992 |
| | 16 | | | W | 0.5 | 2180 | 2109 |
| | 17 | | | | 1.0 | 2000 | 1990 |
| | 18 | | | Y | 0.5 | 2182 | 2110 |
| | 19 | | | | 1.0 | 2005 | 1992 |
| | 21 | | 2.5 | Nil | — | 1900 | 700 |
| | 22 | | | Nb | 0.5 | 1900 | 1805 |
| | 23 | | | | 1.0 | 1805 | 1700 |
| | 24 | | | Mn | 0.5 | 1905 | 1802 |
| | 25 | | | | 1.0 | 1800 | 1702 |
| | 26 | | | Ti | 0.5 | 1902 | 1804 |
| | 27 | | | | 1.0 | 1802 | 1705 |
| | 28 | | | Mg | 0.5 | 1905 | 1805 |
| | 29 | | | | 1.0 | 1805 | 1700 |
| | 30 | | | Zr | 0.5 | 1904 | 1800 |
| | 31 | | | | 1.0 | 1804 | 1705 |
| | 32 | | | Al | 0.5 | 1902 | 1802 |
| | 33 | | | | 1.0 | 1802 | 1702 |
| | 34 | | | Mo | 0.5 | 1905 | 1803 |
| | 35 | | | | 1.0 | 1804 | 1700 |
| | 36 | | | W | 0.5 | 1904 | 1804 |
| | 37 | | | | 1.0 | 1805 | 1702 |
| | 38 | | | Y | 0.5 | 1902 | 1805 |
| | 39 | | | | 1.0 | 1802 | 1705 |

### <<Batteries 1B-1 to 1B-39>>

Batteries 1B-1 to 1B-39 were fabricated in the same manner as in Batteries 1A-1 to 1A-39, respectively, except that the silane coupling agent to be added to the positive electrode material mixture paste was changed to hexyltrimethoxysilane, and the intermittent cycle characteristics thereof were evaluated in the same manner. The results are shown in Table 1B.

TABLE 1B
Lithium composite oxide: LiNi_{0.80}Co_{0.15}Al_{0.05}O₂

| | | | | | | Intermittent cycle | |
|---|---|---|---|---|---|---|---|
| | | | | | | characteristics | |
| | | | | | | Capacity after 500 | |
| | | | | | | cycles | |
| | | Coupling agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 1B | 1 | Hexyl- | 1.0 | Nil | — | 2180 | 802 |
| | 2 | trimethoxy- | | Nb | 0.5 | 2175 | 2110 |
| | 3 | silane | | | 1.0 | 2002 | 1990 |
| | 4 | | | Mn | 0.5 | 2174 | 2108 |
| | 5 | | | | 1.0 | 2002 | 1985 |
| | 6 | | | Ti | 0.5 | 2176 | 2105 |
| | 7 | | | | 1.0 | 2000 | 1992 |
| | 8 | | | Mg | 0.5 | 2177 | 2108 |
| | 9 | | | | 1.0 | 2000 | 1990 |
| | 10 | | | Zr | 0.5 | 2177 | 2107 |
| | 11 | | | | 1.0 | 2004 | 1990 |
| | 12 | | | Al | 0.5 | 2175 | 2108 |
| | 13 | | | | 1.0 | 2003 | 1985 |
| | 14 | | | Mo | 0.5 | 2178 | 2109 |
| | 15 | | | | 1.0 | 2000 | 1992 |
| | 16 | | | W | 0.5 | 2177 | 2110 |
| | 17 | | | | 1.0 | 2002 | 1990 |
| | 18 | | | Y | 0.5 | 2175 | 2110 |
| | 19 | | | | 1.0 | 2004 | 1992 |
| | 21 | | 2.5 | Nil | — | 1905 | 702 |
| | 22 | | | Nb | 0.5 | 1902 | 1800 |
| | 23 | | | | 1.0 | 1800 | 1705 |
| | 24 | | | Mn | 0.5 | 1900 | 1800 |
| | 25 | | | | 1.0 | 1802 | 1702 |
| | 26 | | | Ti | 0.5 | 1902 | 1802 |
| | 27 | | | | 1.0 | 1800 | 1704 |
| | 28 | | | Mg | 0.5 | 1900 | 1802 |
| | 29 | | | | 1.0 | 1802 | 1702 |
| | 30 | | | Zr | 0.5 | 1902 | 1802 |
| | 31 | | | | 1.0 | 1805 | 1700 |
| | 32 | | | Al | 0.5 | 1905 | 1805 |
| | 33 | | | | 1.0 | 1804 | 1700 |
| | 34 | | | Mo | 0.5 | 1902 | 1805 |
| | 35 | | | | 1.0 | 1804 | 1702 |
| | 36 | | | W | 0.5 | 1900 | 1802 |
| | 37 | | | | 1.0 | 1802 | 1704 |
| | 38 | | | Y | 0.5 | 1900 | 1802 |
| | 39 | | | | 1.0 | 1800 | 1700 |

### <<Batteries 1C-1 to 1C-39>>

Batteries 1C-1 to 1C-39 were fabricated in the same manner as in Batteries 1A-1 to 1A-39, respectively, except that the silane coupling agent to be added to the positive electrode material mixture paste was changed to 3-methacryloxypropyltrimethoxysilane, and the intermittent cycle characteristics thereof were evaluated in the same manner. The results are shown in Table 1C.

TABLE 1C
Lithium composite oxide: LiNi_{0.80}Co_{0.15}Al_{0.05}O₂

| | | | | | | Intermittent cycle | |
|---|---|---|---|---|---|---|---|
| | | | | | | characteristics | |
| | | | | | | Capacity after 500 | |
| | | | | | | cycles | |
| | | Coupling agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 1C | 1 | 3-methacryl- | 1.0 | Nil | — | 2180 | 805 |
| | 2 | oxypropyl- | | Nb | 0.5 | 2182 | 2102 |
| | 3 | trimethoxy- | | | 1.0 | 2005 | 1992 |
| | 4 | silane | | Mn | 0.5 | 2180 | 2105 |
| | 5 | | | | 1.0 | 2000 | 1990 |
| | 6 | | | Ti | 0.5 | 2185 | 2100 |
| | 7 | | | | 1.0 | 2002 | 1991 |
| | 8 | | | Mg | 0.5 | 2184 | 2100 |
| | 9 | | | | 1.0 | 2002 | 1994 |
| | 10 | | | Zr | 0.5 | 2180 | 2105 |
| | 11 | | | | 1.0 | 2004 | 1995 |
| | 12 | | | Al | 0.5 | 2182 | 2105 |
| | 13 | | | | 1.0 | 2005 | 1992 |
| | 14 | | | Mo | 0.5 | 2180 | 2102 |
| | 15 | | | | 1.0 | 2005 | 1992 |
| | 16 | | | W | 0.5 | 2180 | 2104 |
| | 17 | | | | 1.0 | 2004 | 1995 |
| | 18 | | | Y | 0.5 | 2182 | 2105 |
| | 19 | | | | 1.0 | 2002 | 1994 |
| | 21 | | 2.5 | Nil | — | 1902 | 700 |
| | 22 | | | Nb | 0.5 | 1900 | 1810 |
| | 23 | | | | 1.0 | 1802 | 1700 |
| | 24 | | | Mn | 0.5 | 1905 | 1812 |
| | 25 | | | | 1.0 | 1800 | 1705 |
| | 26 | | | Ti | 0.5 | 1902 | 1815 |
| | 27 | | | | 1.0 | 1805 | 1702 |
| | 28 | | | Mg | 0.5 | 1904 | 1812 |
| | 29 | | | | 1.0 | 1804 | 1700 |
| | 30 | | | Zr | 0.5 | 1900 | 1810 |
| | 31 | | | | 1.0 | 1804 | 1700 |
| | 32 | | | Al | 0.5 | 1901 | 1810 |
| | 33 | | | | 1.0 | 1802 | 1700 |
| | 34 | | | Mo | 0.5 | 1901 | 1810 |
| | 35 | | | | 1.0 | 1802 | 1702 |
| | 36 | | | W | 0.5 | 1900 | 1812 |
| | 37 | | | | 1.0 | 1802 | 1700 |
| | 38 | | | Y | 0.5 | 1900 | 1815 |
| | 39 | | | | 1.0 | 1800 | 1700 |

### <<Batteries 1D-1 to 1D-39>>

Batteries 1D-1 to 1D-39 were fabricated in the same manner as in Batteries 1A-1 to 1A-39, respectively, except that the silane coupling agent to be added to the positive electrode material mixture paste was changed to 3,3,3-trifluoropropyltrimethoxysilane, and the intermittent cycle characteristics thereof were evaluated in the same manner. The results are shown in Table 1D.

TABLE 1D
Lithium composite oxide: LiNi_{0.80}Co_{0.15}Al_{0.05}O₂

| | | | | | | Intermittent cycle | |
|---|---|---|---|---|---|---|---|
| | | | | | | characteristics | |
| | | | | | | Capacity after 500 | |
| | | | | | | cycles | |
| | | Coupling agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 1D | 1 | 3,3,3- | 1.0 | Nil | — | 2178 | 705 |
| | 2 | trifluoro- | | Nb | 0.5 | 2179 | 2097 |
| | 3 | propyl- | | | 1.0 | 1997 | 1987 |
| | 4 | trimethoxy- | | Mn | 0.5 | 2180 | 2099 |
| | 5 | silane | | | 1.0 | 1995 | 1988 |
| | 6 | | | Ti | 0.5 | 2177 | 2098 |
| | 7 | | | | 1.0 | 1995 | 1985 |
| | 8 | | | Mg | 0.5 | 2178 | 2099 |
| | 9 | | | | 1.0 | 1992 | 1984 |
| | 10 | | | Zr | 0.5 | 2177 | 2097 |
| | 11 | | | | 1.0 | 1992 | 1987 |
| | 12 | | | Al | 0.5 | 2177 | 2097 |
| | 13 | | | | 1.0 | 1995 | 1985 |
| | 14 | | | Mo | 0.5 | 2178 | 2097 |
| | 15 | | | | 1.0 | 1995 | 1988 |
| | 16 | | | W | 0.5 | 2177 | 2097 |
| | 17 | | | | 1.0 | 1997 | 1988 |
| | 18 | | | Y | 0.5 | 2178 | 2097 |
| | 19 | | | | 1.0 | 1997 | 1989 |
| | 21 | | 2.5 | Nil | — | 1902 | 699 |
| | 22 | | | Nb | 0.5 | 1900 | 1810 |
| | 23 | | | | 1.0 | 1802 | 1700 |
| | 24 | | | Mn | 0.5 | 1905 | 1812 |
| | 25 | | | | 1.0 | 1800 | 1705 |
| | 26 | | | Ti | 0.5 | 1902 | 1815 |
| | 27 | | | | 1.0 | 1805 | 1702 |
| | 28 | | | Mg | 0.5 | 1904 | 1812 |
| | 29 | | | | 1.0 | 1804 | 1700 |
| | 30 | | | Zr | 0.5 | 1900 | 1810 |
| | 31 | | | | 1.0 | 1804 | 1700 |
| | 32 | | | Al | 0.5 | 1901 | 1810 |
| | 33 | | | | 1.0 | 1802 | 1700 |
| | 34 | | | Mo | 0.5 | 1901 | 1810 |
| | 35 | | | | 1.0 | 1802 | 1702 |
| | 36 | | | W | 0.5 | 1900 | 1812 |
| | 37 | | | | 1.0 | 1802 | 1700 |
| | 38 | | | Y | 0.5 | 1900 | 1815 |
| | 39 | | | | 1.0 | 1800 | 1700 |

### <<Batteries 1E-1 to 1E-39>>

Batteries 1E-1 to 1E-39 were fabricated in the same manner as in Batteries 1A-1 to 1A-39, respectively, except that the silane coupling agent to be added to the positive electrode material mixture paste was changed to 3,3,4,4,5,5,6,6,6-nonafluorohexyltrichlorosilane, and the intermittent cycle characteristics thereof were evaluated in the same manner. The results are shown in Table 1E.

TABLE 1E
Lithium composite oxide: LiNi_{0.80}Co_{0.15}Al_{0.05}O₂

| | | | | | | Intermittent cycle | |
|---|---|---|---|---|---|---|---|
| | | | | | | characteristics | |
| | | | | | | Capacity after 500 | |
| | | | | | | cycles | |
| | | Coupling agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 1E | 1 | 3,3,4,4,5,5 | 1.0 | Nil | — | 2181 | 812 |
| | 2 | 6,6,6- | | Nb | 0.5 | 2182 | 2105 |
| | 3 | nonafluoro- | | | 1.0 | 2002 | 1995 |
| | 4 | hexyl- | | Mn | 0.5 | 2180 | 2102 |
| | 5 | trichloro- | | | 1.0 | 2000 | 1992 |
| | 6 | silane | | Ti | 0.5 | 2180 | 2100 |
| | 7 | | | | 1.0 | 2002 | 1990 |
| | 8 | | | Mg | 0.5 | 2182 | 2105 |
| | 9 | | | | 1.0 | 2004 | 1990 |
| | 10 | | | Zr | 0.5 | 2185 | 2102 |
| | 11 | | | | 1.0 | 2002 | 1989 |
| | 12 | | | Al | 0.5 | 2180 | 2102 |
| | 13 | | | | 1.0 | 2004 | 1988 |
| | 14 | | | Mo | 0.5 | 2185 | 2100 |
| | 15 | | | | 1.0 | 2005 | 1988 |
| | 16 | | | W | 0.5 | 2184 | 2100 |
| | 17 | | | | 1.0 | 2004 | 1988 |
| | 18 | | | Y | 0.5 | 2184 | 2100 |
| | 19 | | | | 1.0 | 2005 | 1988 |
| | 21 | | 2.5 | Nil | — | 1905 | 711 |
| | 22 | | | Nb | 0.5 | 1902 | 1800 |
| | 23 | | | | 1.0 | 1800 | 1702 |
| | 24 | | | Mn | 0.5 | 1900 | 1802 |
| | 25 | | | | 1.0 | 1802 | 1700 |
| | 26 | | | Ti | 0.5 | 1902 | 1800 |
| | 27 | | | | 1.0 | 1805 | 1700 |
| | 28 | | | Mg | 0.5 | 1905 | 1800 |
| | 29 | | | | 1.0 | 1804 | 1702 |
| | 30 | | | Zr | 0.5 | 1902 | 1800 |
| | 31 | | | | 1.0 | 1804 | 1702 |
| | 32 | | | Al | 0.5 | 1900 | 1800 |
| | 33 | | | | 1.0 | 1804 | 1702 |
| | 34 | | | Mo | 0.5 | 1900 | 1802 |
| | 35 | | | | 1.0 | 1805 | 1700 |
| | 36 | | | W | 0.5 | 1900 | 1802 |
| | 37 | | | | 1.0 | 1805 | 1700 |
| | 38 | | | Y | 0.5 | 1902 | 1802 |
| | 39 | | | | 1.0 | 1805 | 1700 |

### <<Batteries 1F-1 to 1F-39>>

Batteries 1F-1 to 1F-39 were fabricated in the same manner as in Batteries 1A-1 to 1A-39, respectively, except that the silane coupling agent to be added to the positive electrode material mixture paste was changed to 6-triethoxysilyl-2-norbornene, and the intermittent cycle characteristics thereof were evaluated in the same manner. The results are shown in Table 1F.

TABLE 1F
Lithium composite oxide: LiNi_{0.80}CO_{0.15}Al_{0.05}O₂

| | | | | | | Intermittent cycle | |
|---|---|---|---|---|---|---|---|
| | | | | | | characteristics | |
| | | | | | | Capacity after 500 | |
| | | | | | | cycles | |
| | | Coupling agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 1F | 1 | 6-triethoxy- | 1.0 | Nil | — | 2190 | 807 |
| | 2 | silyl-2- | | Nb | 0.5 | 2185 | 2105 |
| | 3 | norbornene | | | 1.0 | 2008 | 1998 |
| | 4 | | | Mn | 0.5 | 2184 | 2105 |
| | 5 | | | | 1.0 | 2004 | 1997 |
| | 6 | | | Ti | 0.5 | 2184 | 2104 |
| | 7 | | | | 1.0 | 2004 | 1999 |
| | 8 | | | Mg | 0.5 | 2185 | 2105 |
| | 9 | | | | 1.0 | 2005 | 1997 |
| | 10 | | | Zr | 0.5 | 2187 | 2107 |
| | 11 | | | | 1.0 | 2007 | 1998 |
| | 12 | | | Al | 0.5 | 2187 | 2107 |
| | 13 | | | | 1.0 | 2008 | 1997 |
| | 14 | | | Mo | 0.5 | 2188 | 2108 |
| | 15 | | | | 1.0 | 2004 | 1998 |
| | 16 | | | W | 0.5 | 2188 | 2108 |
| | 17 | | | | 1.0 | 2005 | 1999 |
| | 18 | | | Y | 0.5 | 2187 | 2108 |
| | 19 | | | | 1.0 | 2007 | 1999 |
| | 21 | | 2.5 | Nil | — | 1907 | 701 |
| | 22 | | | Nb | 0.5 | 1910 | 1808 |
| | 23 | | | | 1.0 | 1812 | 1705 |
| | 24 | | | Mn | 0.5 | 1908 | 1807 |
| | 25 | | | | 1.0 | 1810 | 1704 |
| | 26 | | | Ti | 0.5 | 1907 | 1807 |
| | 27 | | | | 1.0 | 1815 | 1700 |
| | 28 | | | Mg | 0.5 | 1908 | 1805 |
| | 29 | | | | 1.0 | 1814 | 1702 |
| | 30 | | | Zr | 0.5 | 1909 | 1807 |
| | 31 | | | | 1.0 | 1812 | 1705 |
| | 32 | | | Al | 0.5 | 1907 | 1809 |
| | 33 | | | | 1.0 | 1810 | 1704 |
| | 34 | | | Mo | 0.5 | 1908 | 1807 |
| | 35 | | | | 1.0 | 1815 | 1705 |
| | 36 | | | W | 0.5 | 1909 | 1808 |
| | 37 | | | | 1.0 | 1814 | 1705 |
| | 38 | | | Y | 0.5 | 1912 | 1808 |
| | 39 | | | | 1.0 | 1815 | 1704 |

### <<Batteries 1R-1 to 1R-19>>

As Comparative Example, Batteries 1R-1 to 1R-19 were fabricated in the same manner as in Batteries 1A-1 to 1A-19 except that the silane coupling agent was not used, and the intermittent cycle characteristics thereof were evaluated in the same manner. The results are shown in Table 1R.

TABLE 1R
Lithium composite oxide: LiNi_{0.80}Co_{0.15}Al_{0.05}O₂

| | | | | | | Intermittent cycle | |
|---|---|---|---|---|---|---|---|
| | | | | | | characteristics | |
| | | | | | | Capacity after 500 | |
| | | | | | | cycles | |
| | | Coupling agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 1R | 1 | Nil | — | Nil | — | 2180 | 870 |
| | 2 | | | Nb | 0.5 | 2180 | 900 |
| | 3 | | | | 1.0 | 2005 | 810 |
| | 4 | | | Mn | 0.5 | 2182 | 902 |
| | 5 | | | | 1.0 | 2004 | 815 |
| | 6 | | | Ti | 0.5 | 2184 | 905 |
| | 7 | | | | 1.0 | 2005 | 815 |
| | 8 | | | Mg | 0.5 | 2182 | 904 |
| | 9 | | | | 1.0 | 2004 | 800 |
| | 10 | | | Zr | 0.5 | 2185 | 905 |
| | 11 | | | | 1.0 | 2002 | 815 |
| | 12 | | | Al | 0.5 | 2184 | 904 |
| | 13 | | | | 1.0 | 2000 | 812 |
| | 14 | | | Mo | 0.5 | 2185 | 902 |
| | 15 | | | | 1.0 | 2002 | 815 |
| | 16 | | | W | 0.5 | 2185 | 902 |
| | 17 | | | | 1.0 | 2010 | 812 |
| | 18 | | | Y | 0.5 | 2185 | 900 |
| | 19 | | | | 1.0 | 2005 | 810 |

### Example 2

### Batteries 2A-1 to 2A-39

Nickel sulfate, cobalt sulfate and aluminum sulfate were mixed so that the molar ratio of Ni atom, Co atom and Al atom was 34:33:33. To 10 L of water, 3.2 kg of the mixture thus obtained was dissolved to prepare a starting material solution. To the starting material solution, 400 g of sodium hydroxide was added to form a precipitate. The precipitate was washed with water sufficiently, and then dried to yield a coprecipitated hydroxide.

To 3 kg of the Ni—Co—Al coprecipitated hydroxide thus obtained, 784 g of lithium hydroxide was added and mixed, and then the mixture was baked for 10 hours at a synthesizing temperature of 750° C. in an atmosphere with an oxygen partial pressure of 0.5 atm. As a result, a Ni/Co based Li composite oxide containing Al as element L (LiNi_{0.34}Co_{0.33}Al_{0.33}O₂) was obtained.

Batteries 2A-1 to 2A-39 were fabricated using 3-mercaptopropyltrimethoxysilane in the same manner as in Batteries 1A-1 to 1A-39 of Example 1, respectively, except that the Ni/Co based Li composite oxide thus obtained was used, and the intermittent cycle characteristics thereof were evaluated in the same manner. The results are shown in Table 2A.

TABLE 2A
Lithium composite oxide: LiNi_{0.34}Co_{0.33}Al_{0.33}O₂

| | | | | | | Intermittent cycle | |
|---|---|---|---|---|---|---|---|
| | | | | | | characteristics | |
| | | | | | | Capacity after 500 | |
| | | | | | | cycles | |
| | | Coupling agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 2A | 1 | 3-mercapto- | 1.0 | Nil | — | 1920 | 802 |
| | 2 | propyl- | | Nb | 0.5 | 1912 | 1855 |
| | 3 | trimethoxy- | | | 1.0 | 1840 | 1785 |
| | 4 | silane | | Mn | 0.5 | 1915 | 1858 |
| | 5 | | | | 1.0 | 1847 | 1792 |
| | 6 | | | Ti | 0.5 | 1914 | 1876 |
| | 7 | | | | 1.0 | 1845 | 1808 |
| | 8 | | | Mg | 0.5 | 1915 | 1877 |
| | 9 | | | | 1.0 | 1840 | 1803 |
| | 10 | | | Zr | 0.5 | 1911 | 1873 |
| | 11 | | | | 1.0 | 1845 | 1799 |
| | 12 | | | Al | 0.5 | 1915 | 1867 |
| | 13 | | | | 1.0 | 1844 | 1798 |
| | 14 | | | Mo | 0.5 | 1912 | 1864 |
| | 15 | | | | 1.0 | 1846 | 1791 |
| | 16 | | | W | 0.5 | 1911 | 1854 |
| | 17 | | | | 1.0 | 1844 | 1789 |
| | 18 | | | Y | 0.5 | 1910 | 1853 |
| | 19 | | | | 1.0 | 1845 | 1790 |
| | 21 | | 2.5 | Nil | — | 1910 | 700 |
| | 22 | | | Nb | 0.5 | 1915 | 1877 |
| | 23 | | | | 1.0 | 1847 | 1810 |
| | 24 | | | Mn | 0.5 | 1917 | 1879 |
| | 25 | | | | 1.0 | 1840 | 1803 |
| | 26 | | | Ti | 0.5 | 1915 | 1867 |
| | 27 | | | | 1.0 | 1842 | 1796 |
| | 28 | | | Mg | 0.5 | 1917 | 1869 |
| | 29 | | | | 1.0 | 1844 | 1798 |
| | 30 | | | Zr | 0.5 | 1918 | 1870 |
| | 31 | | | | 1.0 | 1847 | 1792 |
| | 32 | | | Al | 0.5 | 1915 | 1858 |
| | 33 | | | | 1.0 | 1842 | 1787 |
| | 34 | | | Mo | 0.5 | 1912 | 1855 |
| | 35 | | | | 1.0 | 1847 | 1792 |
| | 36 | | | W | 0.5 | 1911 | 1873 |
| | 37 | | | | 1.0 | 1845 | 1808 |
| | 38 | | | Y | 0.5 | 1910 | 1872 |
| | 39 | | | | 1.0 | 1840 | 1803 |

### <<Batteries 2B-1 to 2B-39>>

Batteries 2B-1 to 2B-39 were fabricated in the same manner as in Batteries 2A-1 to 2A-39, respectively, except that the silane coupling agent to be added to the positive electrode material mixture paste was changed to hexyltrimethoxysilane, and the intermittent cycle characteristics thereof were evaluated in the same manner. The results are shown in Table 2B.

TABLE 2B
Lithium composite oxide: LiNi_{0.34}Co_{0.33}Al_{0.33}O₂

| | | | | | | Intermittent cycle | |
|---|---|---|---|---|---|---|---|
| | | | | | | characteristics | |
| | | | | | | Capacity after 500 | |
| | | | | | | cycles | |
| | | Coupling agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 2B | 1 | Hexyl- | 1.0 | Nil | — | 1910 | 805 |
| | 2 | trimethoxy- | | Nb | 0.5 | 1911 | 1873 |
| | 3 | silane | | | 1.0 | 1850 | 1813 |
| | 4 | | | Mn | 0.5 | 1912 | 1874 |
| | 5 | | | | 1.0 | 1855 | 1809 |
| | 6 | | | Ti | 0.5 | 1915 | 1867 |
| | 7 | | | | 1.0 | 1854 | 1808 |
| | 8 | | | Mg | 0.5 | 1920 | 1872 |
| | 9 | | | | 1.0 | 1852 | 1796 |
| | 10 | | | Zr | 0.5 | 1918 | 1860 |
| | 11 | | | | 1.0 | 1857 | 1801 |
| | 12 | | | Al | 0.5 | 1917 | 1859 |
| | 13 | | | | 1.0 | 1852 | 1796 |
| | 14 | | | Mo | 0.5 | 1915 | 1877 |
| | 15 | | | | 1.0 | 1848 | 1811 |
| | 16 | | | W | 0.5 | 1910 | 1872 |
| | 17 | | | | 1.0 | 1846 | 1809 |
| | 18 | | | Y | 0.5 | 1910 | 1853 |
| | 19 | | | | 1.0 | 1844 | 1789 |
| | 21 | | 2.5 | Nil | — | 1900 | 700 |
| | 22 | | | Nb | 0.5 | 1912 | 1864 |
| | 23 | | | | 1.0 | 1845 | 1799 |
| | 24 | | | Mn | 0.5 | 1917 | 1869 |
| | 25 | | | | 1.0 | 1844 | 1798 |
| | 26 | | | Ti | 0.5 | 1915 | 1867 |
| | 27 | | | | 1.0 | 1840 | 1803 |
| | 28 | | | Mg | 0.5 | 1910 | 1872 |
| | 29 | | | | 1.0 | 1844 | 1807 |
| | 30 | | | Zr | 0.5 | 1912 | 1874 |
| | 31 | | | | 1.0 | 1845 | 1808 |
| | 32 | | | Al | 0.5 | 1917 | 1869 |
| | 33 | | | | 1.0 | 1840 | 1794 |
| | 34 | | | Mo | 0.5 | 1911 | 1863 |
| | 35 | | | | 1.0 | 1848 | 1802 |
| | 36 | | | W | 0.5 | 1918 | 1860 |
| | 37 | | | | 1.0 | 1842 | 1787 |
| | 38 | | | Y | 0.5 | 1919 | 1861 |
| | 39 | | | | 1.0 | 1840 | 1785 |

### <<Batteries 2C-1 to 2C-39>>

Batteries 2C-1 to 2C-39 were fabricated in the same manner as in Batteries 2A-1 to 2A-39, respectively, except that the silane coupling agent to be added to the positive electrode material mixture paste was changed to 3-methacryloxypropyltrimethoxysilane, and the intermittent cycle characteristics thereof were evaluated in the same manner. The results are shown in Table 2C.

TABLE 2C
Lithium composite oxide: LiNi_{0.34}Co_{0.33}Al_{0.33}O₂

| | | | | | | Intermittent cycle | |
|---|---|---|---|---|---|---|---|
| | | | | | | characteristics | |
| | | | | | | Capacity after 500 | |
| | | | | | | cycles | |
| | | Coupling agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 2C | 1 | 3-methacryl- | 1.0 | Nil | — | 1920 | 807 |
| | 2 | oxypropyl- | | Nb | 0.5 | 1915 | 1877 |
| | 3 | trimethoxy- | | | 1.0 | 1840 | 1803 |
| | 4 | silane | | Mn | 0.5 | 1900 | 1862 |
| | 5 | | | | 1.0 | 1850 | 1795 |
| | 6 | | | Ti | 0.5 | 1910 | 1853 |
| | 7 | | | | 1.0 | 1845 | 1790 |
| | 8 | | | Mg | 0.5 | 1920 | 1862 |
| | 9 | | | | 1.0 | 1844 | 1789 |
| | 10 | | | Zr | 0.5 | 1915 | 1858 |
| | 11 | | | | 1.0 | 1842 | 1787 |
| | 12 | | | Al | 0.5 | 1917 | 1859 |
| | 13 | | | | 1.0 | 1846 | 1800 |
| | 14 | | | Mo | 0.5 | 1916 | 1868 |
| | 15 | | | | 1.0 | 1841 | 1795 |
| | 16 | | | W | 0.5 | 1918 | 1870 |
| | 17 | | | | 1.0 | 1840 | 1794 |
| | 18 | | | Y | 0.5 | 1920 | 1882 |
| | 19 | | | | 1.0 | 1845 | 1808 |
| | 21 | | 2.5 | Nil | — | 1911 | 698 |
| | 22 | | | Nb | 0.5 | 1915 | 1877 |
| | 23 | | | | 1.0 | 1845 | 1790 |
| | 24 | | | Mn | 0.5 | 1917 | 1859 |
| | 25 | | | | 1.0 | 1840 | 1785 |
| | 26 | | | Ti | 0.5 | 1911 | 1854 |
| | 27 | | | | 1.6 | 1842 | 1796 |
| | 28 | | | Mg | 0.5 | 1925 | 1877 |
| | 29 | | | | 1.0 | 1844 | 1798 |
| | 30 | | | Zr | 0.5 | 1915 | 1867 |
| | 31 | | | | 1.0 | 1843 | 1788 |
| | 32 | | | Al | 0.5 | 1920 | 1862 |
| | 33 | | | | 1.0 | 1845 | 1790 |
| | 34 | | | Mo | 0.5 | 1917 | 1859 |
| | 35 | | | | 1.0 | 1844 | 1807 |
| | 36 | | | W | 0.5 | 1910 | 1872 |
| | 37 | | | | 1.0 | 1840 | 1803 |
| | 38 | | | Y | 0.5 | 1912 | 1874 |
| | 39 | | | | 1.0 | 1840 | 1803 |

### <<Batteries 2R-1 to 2R-19>>

As Comparative Example, Batteries 2R-1 to 2R-19 were fabricated in the same manner as in Batteries 2A-1 to 2A-19, respectively, except that the silane coupling agent was not used, and the intermittent cycle characteristics thereof were evaluated in the same manner. The results are shown in Table 2R.

TABLE 2R
Lithium composite oxide: LiNi_{0.34}Co_{0.33}Al_{0.33}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 2R | 1 | Nil | — | Nil | — | 1915 | 712 |
| | 2 | | | Nb | 0.5 | 1911 | 700 |
| | 3 | | | | 1.0 | 1870 | 675 |
| | 4 | | | Mn | 0.5 | 1915 | 702 |
| | 5 | | | | 1.0 | 1872 | 677 |
| | 6 | | | Ti | 0.5 | 1917 | 704 |
| | 7 | | | | 1.0 | 1872 | 678 |
| | 8 | | | Mg | 0.5 | 1917 | 704 |
| | 9 | | | | 1.0 | 1870 | 679 |
| | 10 | | | Zr | 0.5 | 1910 | 702 |
| | 11 | | | | 1.0 | 1877 | 674 |
| | 12 | | | Al | 0.5 | 1912 | 701 |
| | 13 | | | | 1.0 | 1874 | 670 |
| | 14 | | | Mo | 0.5 | 1911 | 708 |
| | 15 | | | | 1.0 | 1872 | 672 |
| | 16 | | | W | 0.5 | 1915 | 701 |
| | 17 | | | | 1.0 | 1871 | 674 |
| | 18 | | | Y | 0.5 | 1917 | 701 |
| | 19 | | | | 1.0 | 1871 | 671 |

### Example 3

### Batteries 3A-1 to 3A-39

Nickel sulfate, cobalt sulfate and titanium nitrate were mixed so that the molar ratio of Ni atom, Co atom and Ti atom was 80:15:5. To 10 L of water, 3.2 kg of the mixture thus obtained was dissolved to prepare a starting material solution. To the starting material solution, 400 g of sodium hydroxide was added to form a precipitate. The precipitate was washed with water sufficiently, and then dried to yield a coprecipitated hydroxide.

To 3 kg of the Ni—Co—Ti coprecipitated hydroxide thus obtained, 784 g of lithium hydroxide was added and mixed, and then the mixture was baked for 10 hours at a synthesizing temperature of 750° C. in an atmosphere with an oxygen partial pressure of 0.5 atm. As a result, a Ni/Co based Li composite oxide containing Ti as element L (LiNi_{0.8}Co_{0.15}Ti_{0.05}O₂) was obtained.

Batteries 3A-1 to 3A-39 were fabricated using 3-mercaptopropyltrimethoxysilane in the same manner as in Batteries 1A-1 to 1A-39 of Example 1, respectively, except that the Ni/Co based Li composite oxide thus obtained was used, and the intermittent cycle characteristics thereof were evaluated in the same manner. The results are shown in Table 3A.

TABLE 3A
Lithium composite oxide: LiNi_{0.80}Co_{0.15}Ti_{0.05}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 3A | 1 | 3-mercapto- | 1.0 | Nil | — | 2182 | 812 |
| | 2 | propyl- | | Nb | 0.5 | 2175 | 2090 |
| | 3 | trimethoxy- | | | 1.0 | 1999 | 1990 |
| | 4 | silane | | Mn | 0.5 | 2175 | 2095 |
| | 5 | | | | 1.0 | 2000 | 1991 |
| | 6 | | | Ti | 0.5 | 2174 | 2092 |
| | 7 | | | | 1.0 | 2002 | 1990 |
| | 8 | | | Mg | 0.5 | 2172 | 2095 |
| | 9 | | | | 1.0 | 2005 | 1991 |
| | 10 | | | Zr | 0.5 | 2170 | 2094 |
| | 11 | | | | 1.0 | 2004 | 1992 |
| | 12 | | | Al | 0.5 | 2175 | 2095 |
| | 13 | | | | 1.0 | 2000 | 1995 |
| | 14 | | | Mo | 0.5 | 2174 | 2090 |
| | 15 | | | | 1.0 | 2004 | 1994 |
| | 16 | | | W | 0.5 | 2175 | 2095 |
| | 17 | | | | 1.0 | 2005 | 1995 |
| | 18 | | | Y | 0.5 | 2170 | 2090 |
| | 19 | | | | 1.0 | 2000 | 1995 |
| | 21 | | 2.5 | Nil | — | 1900 | 689 |
| | 22 | | | Nb | 0.5 | 1905 | 1800 |
| | 23 | | | | 1.0 | 1800 | 1720 |
| | 24 | | | Mn | 0.5 | 1900 | 1805 |
| | 25 | | | | 1.0 | 1802 | 1722 |
| | 26 | | | Ti | 0.5 | 1900 | 1804 |
| | 27 | | | | 1.0 | 1802 | 1720 |
| | 28 | | | Mg | 0.5 | 1905 | 1806 |
| | 29 | | | | 1.0 | 1802 | 1727 |
| | 30 | | | Zr | 0.5 | 1905 | 1807 |
| | 31 | | | | 1.0 | 1800 | 1727 |
| | 32 | | | Al | 0.5 | 1904 | 1807 |
| | 33 | | | | 1.0 | 1800 | 1720 |
| | 34 | | | Mo | 0.5 | 1904 | 1807 |
| | 35 | | | | 1.0 | 1802 | 1727 |
| | 36 | | | W | 0.5 | 1900 | 1808 |
| | 37 | | | | 1.0 | 1805 | 1728 |
| | 38 | | | Y | 0.5 | 1900 | 1800 |
| | 39 | | | | 1.0 | 1800 | 1720 |

### <<Batteries 3B-1 to 3B-39>>

Batteries 3B-1 to 3B-39 were fabricated in the same manner as in Batteries 3A-1 to 3A-39, respectively, except that the silane coupling agent to be added to the positive electrode material mixture paste was changed to hexyltrimethoxysilane, and the intermittent cycle characteristics thereof were evaluated in the same manner. The results are shown in Table 3B.

TABLE 3B
Lithium composite oxide: LiNi_{0.80}Co_{0.15}Ti_{0.05}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 3B | 1 | Hexyl- | 1.0 | Nil | — | 2180 | 811 |
| | 2 | trimethoxy- | | Nb | 0.5 | 2175 | 2080 |
| | 3 | silane | | | 1.0 | 2000 | 1980 |
| | 4 | | | Mn | 0.5 | 2175 | 2079 |
| | 5 | | | | 1.0 | 2000 | 1979 |
| | 6 | | | Ti | 0.5 | 2174 | 2078 |
| | 7 | | | | 1.0 | 2002 | 1980 |
| | 8 | | | Mg | 0.5 | 2174 | 2080 |
| | 9 | | | | 1.0 | 2000 | 1977 |
| | 10 | | | Zr | 0.5 | 2170 | 2080 |
| | 11 | | | | 1.0 | 2002 | 1977 |
| | 12 | | | Al | 0.5 | 2171 | 2079 |
| | 13 | | | | 1.0 | 2004 | 1977 |
| | 14 | | | Mo | 0.5 | 2172 | 2077 |
| | 15 | | | | 1.0 | 2002 | 1987 |
| | 16 | | | W | 0.5 | 2172 | 2077 |
| | 17 | | | | 1.0 | 2000 | 1987 |
| | 18 | | | Y | 0.5 | 2170 | 2079 |
| | 19 | | | | 1.0 | 2000 | 1987 |
| | 21 | | 2.5 | Nil | — | 1900 | 698 |
| | 22 | | | Nb | 0.5 | 1890 | 1805 |
| | 23 | | | | 1.0 | 1800 | 1700 |
| | 24 | | | Mn | 0.5 | 1891 | 1802 |
| | 25 | | | | 1.0 | 1799 | 1700 |
| | 26 | | | Ti | 0.5 | 1890 | 1803 |
| | 27 | | | | 1.0 | 1797 | 1702 |
| | 28 | | | Mg | 0.5 | 1891 | 1804 |
| | 29 | | | | 1.0 | 1799 | 1705 |
| | 30 | | | Zr | 0.5 | 1889 | 1805 |
| | 31 | | | | 1.0 | 1799 | 1704 |
| | 32 | | | Al | 0.5 | 1889 | 1805 |
| | 33 | | | | 1.0 | 1800 | 1702 |
| | 34 | | | Mo | 0.5 | 1892 | 1805 |
| | 35 | | | | 1.0 | 1800 | 1702 |
| | 36 | | | W | 0.5 | 1890 | 1805 |
| | 37 | | | | 1.0 | 1800 | 1703 |
| | 38 | | | Y | 0.5 | 1890 | 1805 |
| | 39 | | | | 1.0 | 1800 | 1705 |

### <<Batteries 3C-1 to 3C-39>>

Batteries 3C-1 to 3C-39 were fabricated in the same manner as in Batteries 3A-1 to 3A-39, respectively, except that the silane coupling agent to be added to the positive electrode material mixture paste was changed to 3-methacryloxypropyltrimethoxysilane, and the intermittent cycle characteristics thereof were evaluated in the same manner. The results are shown in Table 3C.

TABLE 3C
Lithium composite oxide: LiNi_{0.80}Co_{0.15}Ti_{0.05}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 3C | 1 | 3-methacryl- | 1.0 | Nil | — | 2180 | 800 |
| | 2 | oxypropyl- | | Nb | 0.5 | 2185 | 2050 |
| | 3 | trimethoxy- | | | 1.0 | 2000 | 1980 |
| | 4 | silane | | Mn | 0.5 | 2184 | 2048 |
| | 5 | | | | 1.0 | 2000 | 1982 |
| | 6 | | | Ti | 0.5 | 2185 | 2050 |
| | 7 | | | | 1.0 | 1999 | 1982 |
| | 8 | | | Mg | 0.5 | 2185 | 2052 |
| | 9 | | | | 1.0 | 1998 | 1984 |
| | 10 | | | Zr | 0.5 | 2180 | 2049 |
| | 11 | | | | 1.0 | 1997 | 1980 |
| | 12 | | | Al | 0.5 | 2185 | 2048 |
| | 13 | | | | 1.0 | 2000 | 1984 |
| | 14 | | | Mo | 0.5 | 2180 | 2050 |
| | 15 | | | | 1.0 | 2000 | 1985 |
| | 16 | | | W | 0.5 | 2180 | 2050 |
| | 17 | | | | 1.0 | 2001 | 1980 |
| | 18 | | | Y | 0.5 | 2180 | 2052 |
| | 19 | | | | 1.0 | 1999 | 1980 |
| | 21 | | 2.5 | Nil | — | 1900 | 705 |
| | 22 | | | Nb | 0.5 | 1905 | 1810 |
| | 23 | | | | 1.0 | 1810 | 1710 |
| | 24 | | | Mn | 0.5 | 1900 | 1808 |
| | 25 | | | | 1.0 | 1815 | 1711 |
| | 26 | | | Ti | 0.5 | 1905 | 1804 |
| | 27 | | | | 1.0 | 1810 | 1710 |
| | 28 | | | Mg | 0.5 | 1900 | 1805 |
| | 29 | | | | 1.0 | 1810 | 1710 |
| | 30 | | | Zr | 0.5 | 1900 | 1807 |
| | 31 | | | | 1.0 | 1814 | 1711 |
| | 32 | | | Al | 0.5 | 1905 | 1801 |
| | 33 | | | | 1.0 | 1812 | 1710 |
| | 34 | | | Mo | 0.5 | 1905 | 1800 |
| | 35 | | | | 1.0 | 1813 | 1711 |
| | 36 | | | W | 0.5 | 1905 | 1805 |
| | 37 | | | | 1.0 | 1814 | 1711 |
| | 38 | | | Y | 0.5 | 1905 | 1810 |
| | 39 | | | | 1.0 | 1815 | 1711 |

### <<Batteries 3D-1 to 3D-39>>

Batteries 3D-1 to 3D-39 were fabricated in the same manner as in Batteries 3A-1 to 3A-39, respectively, except that the silane coupling agent to be added to the positive electrode material mixture paste was changed to 3,3,3-trifluoropropyltrimethoxysilane, and the intermittent cycle characteristics thereof were evaluated in the same manner. The results are shown in Table 3D.

TABLE 3D
Lithium composite oxide: LiNi_{0.80}Co_{0.15}Ti_{0.05}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 3D | 1 | 3,3,3- | 1.0 | Nil | — | 2180 | 709 |
| | 2 | trifluoro- | | Nb | 0.5 | 2180 | 2105 |
| | 3 | propyl- | | | 1.0 | 2005 | 1990 |
| | 4 | trimethoxy- | | Mn | 0.5 | 2178 | 2100 |
| | 5 | silane | | | 1.0 | 2002 | 1991 |
| | 6 | | | Ti | 0.5 | 2179 | 2105 |
| | 7 | | | | 1.0 | 2005 | 1990 |
| | 8 | | | Mg | 0.5 | 2178 | 2105 |
| | 9 | | | | 1.0 | 2000 | 1995 |
| | 10 | | | Zr | 0.5 | 2177 | 2100 |
| | 11 | | | | 1.0 | 2000 | 1995 |
| | 12 | | | Al | 0.5 | 2179 | 2100 |
| | 13 | | | | 1.0 | 2005 | 1992 |
| | 14 | | | Mo | 0.5 | 2178 | 2103 |
| | 15 | | | | 1.0 | 2005 | 1995 |
| | 16 | | | W | 0.5 | 2177 | 2103 |
| | 17 | | | | 1.0 | 2002 | 1990 |
| | 18 | | | Y | 0.5 | 2177 | 2103 |
| | 19 | | | | 1.0 | 2002 | 1990 |
| | 21 | | 2.5 | Nil | — | 1900 | 701 |
| | 22 | | | Nb | 0.5 | 1902 | 1800 |
| | 23 | | | | 1.0 | 1804 | 1717 |
| | 24 | | | Mn | 0.5 | 1900 | 1802 |
| | 25 | | | | 1.0 | 1800 | 1715 |
| | 26 | | | Ti | 0.5 | 1900 | 1804 |
| | 27 | | | | 1.0 | 1802 | 1712 |
| | 28 | | | Mg | 0.5 | 1905 | 1805 |
| | 29 | | | | 1.0 | 1800 | 1714 |
| | 30 | | | Zr | 0.5 | 1905 | 1800 |
| | 31 | | | | 1.0 | 1804 | 1713 |
| | 32 | | | Al | 0.5 | 1904 | 1802 |
| | 33 | | | | 1.0 | 1804 | 1713 |
| | 34 | | | Mo | 0.5 | 1904 | 1805 |
| | 35 | | | | 1.0 | 1805 | 1717 |
| | 36 | | | W | 0.5 | 1900 | 1805 |
| | 37 | | | | 1.0 | 1805 | 1717 |
| | 38 | | | Y | 0.5 | 1905 | 1805 |
| | 39 | | | | 1.0 | 1804 | 1717 |

### <<Batteries 3E-1 to 3E-39>>

Batteries 3E-1 to 3E-39 were fabricated in the same manner as in Batteries 3A-1 to 3A-39, respectively, except that the silane coupling agent to be added to the positive electrode material mixture paste was changed to 3,3,4,4,5,5,6,6,6-nonafluorohexyltrichlorosilane, and the intermittent cycle characteristics thereof were evaluated in the same manner. The results are shown in Table 3E.

TABLE 3E
Lithium composite oxide: LiNi_{0.80}Co_{0.15}Ti_{0.05}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 3E | 1 | 3,3,4,4,5,5, | 1.0 | Nil | — | 2190 | 817 |
| | 2 | 6,6,6- | | Nb | 0.5 | 2185 | 2105 |
| | 3 | nonafluoro- | | | 1.0 | 2008 | 1998 |
| | 4 | hexyl- | | Mn | 0.5 | 2184 | 2105 |
| | 5 | trichloro- | | | 1.0 | 2004 | 1997 |
| | 6 | silane | | Ti | 0.5 | 2184 | 2104 |
| | 7 | | | | 1.0 | 2004 | 1999 |
| | 8 | | | Mg | 0.5 | 2185 | 2105 |
| | 9 | | | | 1.0 | 2005 | 1997 |
| | 10 | | | Zr | 0.5 | 2187 | 2107 |
| | 11 | | | | 1.0 | 2007 | 1998 |
| | 12 | | | Al | 0.5 | 2187 | 2107 |
| | 13 | | | | 1.0 | 2008 | 1997 |
| | 14 | | | Mo | 0.5 | 2188 | 2108 |
| | 15 | | | | 1.0 | 2004 | 1998 |
| | 16 | | | W | 0.5 | 2188 | 2108 |
| | 17 | | | | 1.0 | 2005 | 1999 |
| | 18 | | | Y | 0.5 | 2187 | 2108 |
| | 19 | | | | 1.0 | 2007 | 1999 |
| | 21 | | 2.5 | Nil | — | 1910 | 704 |
| | 22 | | | Nb | 0.5 | 1910 | 1808 |
| | 23 | | | | 1.0 | 1812 | 1705 |
| | 24 | | | Mn | 0.5 | 1908 | 1807 |
| | 25 | | | | 1.0 | 1810 | 1704 |
| | 26 | | | Ti | 0.5 | 1907 | 1807 |
| | 27 | | | | 1.0 | 1815 | 1700 |
| | 28 | | | Mg | 0.5 | 1908 | 1805 |
| | 29 | | | | 1.0 | 1814 | 1702 |
| | 30 | | | Zr | 0.5 | 1909 | 1807 |
| | 31 | | | | 1.0 | 1812 | 1705 |
| | 32 | | | Al | 0.5 | 1907 | 1809 |
| | 33 | | | | 1.0 | 1810 | 1704 |
| | 34 | | | Mo | 0.5 | 1908 | 1807 |
| | 35 | | | | 1.0 | 1815 | 1705 |
| | 36 | | | W | 0.5 | 1909 | 1808 |
| | 37 | | | | 1.0 | 1814 | 1705 |
| | 38 | | | Y | 0.5 | 1912 | 1808 |
| | 39 | | | | 1.0 | 1815 | 1704 |

### <<Batteries 3F-1 to 3F-39>>

Batteries 3F-1 to 3F-39 were fabricated in the same manner as in Batteries 3A-1 to 3A-39, respectively, except that the silane coupling agent to be added to the positive electrode material mixture paste was changed to 6-triethoxysilyl-2-norbornene, and the intermittent cycle characteristics thereof were evaluated in the same manner. The results are shown in Table 3F.

Lithium composite oxide: LiNi_{0.80}Co_{0.15}Ti_{0.05}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 3F | 1 | 6-triethoxy- | 1.0 | Nil | — | 2190 | 822 |
| | 2 | silyl-2- | | Nb | 0.5 | 2185 | 2105 |
| | 3 | norbornene | | | 1.0 | 2008 | 1998 |
| | 4 | | | Mn | 0.5 | 2184 | 2105 |
| | 5 | | | | 1.0 | 2004 | 1997 |
| | 6 | | | Ti | 0.5 | 2184 | 2104 |
| | 7 | | | | 1.0 | 2004 | 1999 |
| | 8 | | | Mg | 0.5 | 2185 | 2105 |
| | 9 | | | | 1.0 | 2005 | 1997 |
| | 10 | | | Zr | 0.5 | 2187 | 2107 |
| | 11 | | | | 1.0 | 2007 | 1998 |
| | 12 | | | Al | 0.5 | 2187 | 2107 |
| | 13 | | | | 1.0 | 2008 | 1997 |
| | 14 | | | Mo | 0.5 | 2188 | 2108 |
| | 15 | | | | 1.0 | 2004 | 1998 |
| | 16 | | | W | 0.5 | 2188 | 2108 |
| | 17 | | | | 1.0 | 2005 | 1999 |
| | 18 | | | Y | 0.5 | 2187 | 2108 |
| | 19 | | | | 1.0 | 2007 | 1999 |
| | 21 | | 2.5 | Nil | — | 1911 | 702 |
| | 22 | | | Nb | 0.5 | 1910 | 1808 |
| | 23 | | | | 1.0 | 1812 | 1705 |
| | 24 | | | Mn | 0.5 | 1908 | 1807 |
| | 25 | | | | 1.0 | 1810 | 1704 |
| | 26 | | | Ti | 0.5 | 1907 | 1807 |
| | 27 | | | | 1.0 | 1815 | 1700 |
| | 28 | | | Mg | 0.5 | 1908 | 1805 |
| | 29 | | | | 1.0 | 1814 | 1702 |
| | 30 | | | Zr | 0.5 | 1909 | 1807 |
| | 31 | | | | 1.0 | 1812 | 1705 |
| | 32 | | | Al | 0.5 | 1907 | 1809 |
| | 33 | | | | 1.0 | 1810 | 1704 |
| | 34 | | | Mo | 0.5 | 1908 | 1807 |
| | 35 | | | | 1.0 | 1815 | 1705 |
| | 36 | | | W | 0.5 | 1909 | 1808 |
| | 37 | | | | 1.0 | 1814 | 1705 |
| | 38 | | | Y | 0.5 | 1912 | 1808 |
| | 39 | | | | 1.0 | 1815 | 1704 |

### <<Batteries 3R-1 to 3R-19>>

As Comparative Example, Batteries 3R-1 to 3R-19 were fabricated in the same manner as in Batteries 3A-1 to 3A-19, respectively, except that the silane coupling agent was not used, and the intermittent cycle characteristics thereof were evaluated in the same manner. The results are shown in Table 3R.

TABLE 3R
Lithium composite oxide: LiNi_{0.80}Co_{0.15}Ti_{0.05}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 3R | 1 | Nil | — | Nil | — | 2190 | 897 |
| | 2 | | | Nb | 0.5 | 2184 | 900 |
| | 3 | | | | 1.0 | 2000 | 810 |
| | 4 | | | Mn | 0.5 | 2187 | 905 |
| | 5 | | | | 1.0 | 2002 | 815 |
| | 6 | | | Ti | 0.5 | 2187 | 904 |
| | 7 | | | | 1.0 | 2003 | 812 |
| | 8 | | | Mg | 0.5 | 2180 | 904 |
| | 9 | | | | 1.0 | 2003 | 815 |
| | 10 | | | Zr | 0.5 | 2180 | 907 |
| | 11 | | | | 1.0 | 2004 | 814 |
| | 12 | | | Al | 0.5 | 2188 | 900 |
| | 13 | | | | 1.0 | 2002 | 814 |
| | 14 | | | Mo | 0.5 | 2188 | 907 |
| | 15 | | | | 1.0 | 2002 | 810 |
| | 16 | | | W | 0.5 | 2187 | 907 |
| | 17 | | | | 1.0 | 2002 | 813 |
| | 18 | | | Y | 0.5 | 2187 | 900 |
| | 19 | | | | 1.0 | 2002 | 812 |

### Example 4

### Batteries 4A-1 to 4A-39

Nickel sulfate, cobalt sulfate and titanium nitrate were mixed so that the molar ratio of Ni atom, Co atom and Ti atom was 34:33:33. To 10 L of water, 3.2 kg of the mixture thus obtained was dissolved to prepare a starting material solution. To the starting material solution, 400 g of sodium hydroxide was added to form a precipitate. The precipitate was washed with water sufficiently, and then dried to yield a coprecipitated hydroxide.

To 3 kg of the Ni—Co—Ti coprecipitated hydroxide thus obtained, 784 g of lithium hydroxide was added and mixed, and then the mixture was baked for 10 hours at a synthesizing temperature of 750° C. in an atmosphere with an oxygen partial pressure of 0.5 atm. As a result, a Ni/Co based Li composite oxide containing Ti as element L (LiNi_{0.34}Co_{0.33}Ti_{0.33}O₂) was obtained.

Batteries 4A-1 to 4A-39 were fabricated using 3-mercaptopropyltrimethoxysilane in the same manner as in Batteries 1A-1 to 1A-39 of Example 1, respectively, except that the Ni/Co based Li composite oxide thus obtained was used, and the intermittent cycle characteristics thereof were evaluated in the same manner. The results are shown in Table 4A.

TABLE 4A
Lithium composite oxide: LiNi_{0.34}Co_{0.33}Ti_{0.33}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 4A | 1 | 3-mercapto- | 1.0 | Nil | — | 1912 | 787 |
| | 2 | propyl- | | Nb | 0.5 | 1910 | 1862 |
| | 3 | trimethoxy- | | | 1.0 | 1825 | 1779 |
| | 4 | silane | | Mn | 0.5 | 1915 | 1867 |
| | 5 | | | | 1.0 | 1824 | 1778 |
| | 6 | | | Ti | 0.5 | 1911 | 1863 |
| | 7 | | | | 1.0 | 1827 | 1781 |
| | 8 | | | Mg | 0.5 | 1915 | 1867 |
| | 9 | | | | 1.0 | 1825 | 1770 |
| | 10 | | | Zr | 0.5 | 1917 | 1859 |
| | 11 | | | | 1.0 | 1829 | 1774 |
| | 12 | | | Al | 0.5 | 1915 | 1858 |
| | 13 | | | | 1.0 | 1824 | 1769 |
| | 14 | | | Mo | 0.5 | 1915 | 1858 |
| | 15 | | | | 1.0 | 1828 | 1773 |
| | 16 | | | W | 0.5 | 1918 | 1860 |
| | 17 | | | | 1.0 | 1827 | 1772 |
| | 18 | | | Y | 0.5 | 1911 | 1854 |
| | 19 | | | | 1.0 | 1825 | 1770 |
| | 21 | | 2.5 | Nil | — | 1915 | 751 |
| | 22 | | | Nb | 0.5 | 1918 | 1880 |
| | 23 | | | | 1.0 | 1829 | 1792 |
| | 24 | | | Mn | 0.5 | 1912 | 1874 |
| | 25 | | | | 1.0 | 1827 | 1790 |
| | 26 | | | Ti | 0.5 | 1915 | 1877 |
| | 27 | | | | 1.0 | 1826 | 1789 |
| | 28 | | | Mg | 0.5 | 1911 | 1873 |
| | 29 | | | | 1.0 | 1827 | 1790 |
| | 30 | | | Zr | 0.5 | 1914 | 1876 |
| | 31 | | | | 1.0 | 1825 | 1789 |
| | 32 | | | Al | 0.5 | 1915 | 1877 |
| | 33 | | | | 1.0 | 1827 | 1772 |
| | 34 | | | Mo | 0.5 | 1914 | 1857 |
| | 35 | | | | 1.0 | 1829 | 1774 |
| | 36 | | | W | 0.5 | 1910 | 1853 |
| | 37 | | | | 1.0 | 1827 | 1772 |
| | 38 | | | Y | 0.5 | 1912 | 1855 |
| | 39 | | | | 1.0 | 1825 | 1770 |

### <<Batteries 4B-1 to 4B-39>>

Batteries 4B-1 to 4B-39 were fabricated in the same manner as in Batteries 4A-1 to 4A-39, respectively, except that the silane coupling agent to be added to the positive electrode material mixture paste was changed to hexyltrimethoxysilane, and the intermittent cycle characteristics thereof were evaluated in the same manner. The results are shown in Table 4B.

TABLE 4B
Lithium composite oxide: LiNi_{0.34}Co_{0.33}Ti_{0.33}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 4B | 1 | Hexyl- | 1.0 | Nil | — | 1905 | 800 |
| | 2 | trimethoxy- | | Nb | 0.5 | 1910 | 1872 |
| | 3 | silane | | | 1.0 | 1830 | 1793 |
| | 4 | | | Mn | 0.5 | 1908 | 1870 |
| | 5 | | | | 1.0 | 1835 | 1798 |
| | 6 | | | Ti | 0.5 | 1907 | 1850 |
| | 7 | | | | 1.0 | 1834 | 1779 |
| | 8 | | | Mg | 0.5 | 1908 | 1851 |
| | 9 | | | | 1.0 | 1835 | 1780 |
| | 10 | | | Zr | 0.5 | 1905 | 1857 |
| | 11 | | | | 1.0 | 1834 | 1788 |
| | 12 | | | Al | 0.5 | 1907 | 1859 |
| | 13 | | | | 1.0 | 1836 | 1790 |
| | 14 | | | Mo | 0.5 | 1911 | 1863 |
| | 15 | | | | 1.0 | 1837 | 1791 |
| | 16 | | | W | 0.5 | 1909 | 1871 |
| | 17 | | | | 1.0 | 1839 | 1802 |
| | 18 | | | Y | 0.5 | 1912 | 1874 |
| | 19 | | | | 1.0 | 1838 | 1801 |
| | 21 | | 2.5 | Nil | — | 1910 | 754 |
| | 22 | | | Nb | 0.5 | 1915 | 1877 |
| | 23 | | | | 1.0 | 1830 | 1793 |
| | 24 | | | Mn | 0.5 | 1918 | 1880 |
| | 25 | | | | 1.0 | 1832 | 1795 |
| | 26 | | | Ti | 0.5 | 1912 | 1874 |
| | 27 | | | | 1.0 | 1831 | 1794 |
| | 28 | | | Mg | 0.5 | 1914 | 1876 |
| | 29 | | | | 1.0 | 1834 | 1797 |
| | 30 | | | Zr | 0.5 | 1914 | 1876 |
| | 31 | | | | 1.0 | 1834 | 1797 |
| | 32 | | | Al | 0.5 | 1915 | 1877 |
| | 33 | | | | 1.0 | 1835 | 1780 |
| | 34 | | | Mo | 0.5 | 1911 | 1854 |
| | 35 | | | | 1.0 | 1830 | 1775 |
| | 36 | | | W | 0.5 | 1910 | 1853 |
| | 37 | | | | 1.0 | 1832 | 1777 |
| | 38 | | | Y | 0.5 | 1912 | 1855 |
| | 39 | | | | 1.0 | 1833 | 1778 |

### <<Batteries 4C-1 to 4C-39>>

Batteries 4C-1 to 4C-39 were fabricated in the same manner as in Batteries 4A-1 to 4A-39, respectively, except that the silane coupling agent to be added to the positive electrode material mixture paste was changed to 3-methacryloxypropyltrimethoxysilane, and the intermittent cycle characteristics thereof were evaluated in the same manner. The results are shown in Table 4C.

TABLE 4C
Lithium composite oxide: LiNi_{0.34}Co_{0.33}Ti_{0.33}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 4C | 1 | 3-methacryl- | 1.0 | Nil | — | 1920 | 892 |
| | 2 | oxypropyl- | | Nb | 0.5 | 1915 | 1877 |
| | 3 | trimethoxy- | | | 1.0 | 1835 | 1798 |
| | 4 | silane | | Mn | 0.5 | 1917 | 1879 |
| | 5 | | | | 1.0 | 1834 | 1752 |
| | 6 | | | Ti | 0.5 | 1918 | 1833 |
| | 7 | | | | 1.0 | 1837 | 1755 |
| | 8 | | | Mg | 0.5 | 1914 | 1829 |
| | 9 | | | | 1.0 | 1835 | 1753 |
| | 10 | | | Zr | 0.5 | 1911 | 1854 |
| | 11 | | | | 1.0 | 1837 | 1782 |
| | 12 | | | Al | 0.5 | 1915 | 1858 |
| | 13 | | | | 1.0 | 1839 | 1784 |
| | 14 | | | Mo | 0.5 | 1912 | 1855 |
| | 15 | | | | 1.0 | 1834 | 1779 |
| | 16 | | | W | 0.5 | 1917 | 1859 |
| | 17 | | | | 1.0 | 1833 | 1778 |
| | 18 | | | Y | 0.5 | 1917 | 1859 |
| | 19 | | | | 1.0 | 1830 | 1775 |
| | 21 | | 2.5 | Nil | — | 1915 | 800 |
| | 22 | | | Nb | 0.5 | 1914 | 1829 |
| | 23 | | | | 1.0 | 1837 | 1755 |
| | 24 | | | Mn | 0.5 | 1912 | 1827 |
| | 25 | | | | 1.0 | 1834 | 1752 |
| | 26 | | | Ti | 0.5 | 1911 | 1873 |
| | 27 | | | | 1.0 | 1830 | 1793 |
| | 28 | | | Mg | 0.5 | 1910 | 1872 |
| | 29 | | | | 1.0 | 1831 | 1794 |
| | 30 | | | Zr | 0.5 | 1915 | 1858 |
| | 31 | | | | 1.0 | 1832 | 1777 |
| | 32 | | | Al | 0.5 | 1914 | 1857 |
| | 33 | | | | 1.0 | 1834 | 1779 |
| | 34 | | | Mo | 0.5 | 1912 | 1827 |
| | 35 | | | | 1.0 | 1834 | 1752 |
| | 36 | | | W | 0.5 | 1911 | 1826 |
| | 37 | | | | 1.0 | 1833 | 1796 |
| | 38 | | | Y | 0.5 | 1910 | 1872 |
| | 39 | | | | 1.0 | 1830 | 1793 |

### <<Batteries 4R-1 to 4R-19>>

As Comparative Example, Batteries 4R-1 to 4R-19 were fabricated in the same manner as in Batteries 4A-1 to 4A-19, respectively, except that the silane coupling agent was not used, and the intermittent cycle characteristics thereof were evaluated in the same manner. The results are shown in Table 4R.

TABLE 4R
Lithium composite oxide: LiNi_{0.34}Co_{0.33}Ti_{0.33}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 4R | 1 | Nil | — | Nil | — | 1920 | 725 |
| | 2 | | | Nb | 0.5 | 1912 | 754 |
| | 3 | | | | 1.0 | 1842 | 702 |
| | 4 | | | Mn | 0.5 | 1910 | 754 |
| | 5 | | | | 1.0 | 1840 | 701 |
| | 6 | | | Ti | 0.5 | 1911 | 755 |
| | 7 | | | | 1.0 | 1840 | 700 |
| | 8 | | | Mg | 0.5 | 1914 | 752 |
| | 9 | | | | 1.0 | 1840 | 704 |
| | 10 | | | Zr | 0.5 | 1915 | 751 |
| | 11 | | | | 1.0 | 1847 | 706 |
| | 12 | | | Al | 0.5 | 1918 | 758 |
| | 13 | | | | 1.0 | 1845 | 702 |
| | 14 | | | Mo | 0.5 | 1910 | 754 |
| | 15 | | | | 1.0 | 1844 | 701 |
| | 16 | | | W | 0.5 | 1911 | 752 |
| | 17 | | | | 1.0 | 1842 | 705 |
| | 18 | | | Y | 0.5 | 1912 | 755 |
| | 19 | | | | 1.0 | 1843 | 700 |

### Example 5

### Batteries 5A-1 to 5A-39

Nickel sulfate, cobalt sulfate and manganese sulfate were mixed so that the molar ratio of Ni atom, Co atom and Mn atom was 34:33:33. To 10 L of water, 3.2 kg of the mixture thus obtained was dissolved to prepare a starting material solution. To the starting material solution, 400 g of sodium hydroxide was added to form a precipitate. The precipitate was washed with water sufficiently, and then dried to yield a coprecipitated hydroxide.

To 3 kg of the Ni—Co—Mn coprecipitated hydroxide thus obtained, 784 g of lithium hydroxide was added and mixed, and then the mixture was baked for 10 hours at a synthesizing temperature of 750° C. in an atmosphere with an oxygen partial pressure of 0.5 atm. As a result, a Ni/Co based Li composite oxide containing Mn as element L (LiNi_{0.34}Co_{0.33}Mn_{0.33}O₂) was obtained.

Batteries 5A-1 to 5A-39 were fabricated using 3-mercaptopropyltrimethoxysilane in the same manner as in Batteries 1A-1 to 1A-39 of Example 1, respectively, except that the Ni/Co based Li composite oxide thus obtained was used, and the intermittent cycle characteristics thereof were evaluated in the same manner. The results are shown in Table 5A.

TABLE 5A
Lithium composite oxide: LiNi_{0.34}Co_{0.33}Mn_{0.33}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 5A | 1 | 3-mercapto- | 1.0 | Nil | — | 2007 | 789 |
| | 2 | propyl- | | Nb | 0.5 | 2001 | 1903 |
| | 3 | trimethoxy- | | | 1.0 | 1865 | 1750 |
| | 4 | silane | | Mn | 0.5 | 2002 | 1900 |
| | 5 | | | | 1.0 | 1866 | 1748 |
| | 6 | | | Ti | 0.5 | 2005 | 1902 |
| | 7 | | | | 1.0 | 1866 | 1749 |
| | 8 | | | Mg | 0.5 | 2004 | 1905 |
| | 9 | | | | 1.0 | 1867 | 1745 |
| | 10 | | | Zr | 0.5 | 2007 | 1904 |
| | 11 | | | | 1.0 | 1865 | 1744 |
| | 12 | | | Al | 0.5 | 2000 | 1900 |
| | 13 | | | | 1.0 | 1860 | 1743 |
| | 14 | | | Mo | 0.5 | 2001 | 1905 |
| | 15 | | | | 1.0 | 1862 | 1749 |
| | 16 | | | W | 0.5 | 2002 | 1907 |
| | 17 | | | | 1.0 | 1865 | 1745 |
| | 18 | | | Y | 0.5 | 2005 | 1907 |
| | 19 | | | | 1.0 | 1864 | 1748 |
| | 21 | | 2.5 | Nil | — | 1770 | 720 |
| | 22 | | | Nb | 0.5 | 1748 | 1698 |
| | 23 | | | | 1.0 | 1645 | 1599 |
| | 24 | | | Mn | 0.5 | 1747 | 1690 |
| | 25 | | | | 1.0 | 1648 | 1598 |
| | 26 | | | Ti | 0.5 | 1749 | 1692 |
| | 27 | | | | 1.0 | 1644 | 1597 |
| | 28 | | | Mg | 0.5 | 1745 | 1692 |
| | 29 | | | | 1.0 | 1642 | 1599 |
| | 30 | | | Zr | 0.5 | 1744 | 1695 |
| | 31 | | | | 1.0 | 1645 | 1598 |
| | 32 | | | Al | 0.5 | 1740 | 1697 |
| | 33 | | | | 1.0 | 1640 | 1597 |
| | 34 | | | Mo | 0.5 | 1748 | 1699 |
| | 35 | | | | 1.0 | 1642 | 1595 |
| | 36 | | | W | 0.5 | 1749 | 1698 |
| | 37 | | | | 1.0 | 1643 | 1599 |
| | 38 | | | Y | 0.5 | 1750 | 1695 |
| | 39 | | | | 1.0 | 1645 | 1595 |

### <<Batteries 5B-1 to 5B-39>>

Batteries 5B-1 to 5B-39 were fabricated in the same manner as in Batteries 5A-1 to 5A-39, respectively, except that the silane coupling agent to be added to the positive electrode material mixture paste was changed to hexyltrimethoxysilane, and the intermittent cycle characteristics thereof were evaluated in the same manner. The results are shown in Table 5B.

TABLE 5B
Lithium composite oxide: LiNi_{0.34}Co_{0.33}Mn_{0.33}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 5B | 1 | Hexyl- | 1.0 | Nil | — | 2007 | 804 |
| | 2 | trimethoxy- | | Nb | 0.5 | 2005 | 1905 |
| | 3 | silane | | | 1.0 | 1842 | 1755 |
| | 4 | | | Mn | 0.5 | 2002 | 1907 |
| | 5 | | | | 1.0 | 1840 | 1757 |
| | 6 | | | Ti | 0.5 | 2004 | 1905 |
| | 7 | | | | 1.0 | 1845 | 1754 |
| | 8 | | | Mg | 0.5 | 2002 | 1904 |
| | 9 | | | | 1.0 | 1844 | 1748 |
| | 10 | | | Zr | 0.5 | 2000 | 1905 |
| | 11 | | | | 1.0 | 1845 | 1749 |
| | 12 | | | Al | 0.5 | 2001 | 1905 |
| | 13 | | | | 1.0 | 1841 | 1757 |
| | 14 | | | Mo | 0.5 | 2002 | 1904 |
| | 15 | | | | 1.0 | 1847 | 1755 |
| | 16 | | | W | 0.5 | 2005 | 1904 |
| | 17 | | | | 1.0 | 1845 | 1757 |
| | 18 | | | Y | 0.5 | 2004 | 1907 |
| | 19 | | | | 1.0 | 1847 | 1547 |
| | 21 | | 2.5 | Nil | — | 1750 | 702 |
| | 22 | | | Nb | 0.5 | 1749 | 1607 |
| | 23 | | | | 1.0 | 1645 | 1605 |
| | 24 | | | Mn | 0.5 | 1747 | 1704 |
| | 25 | | | | 1.0 | 1646 | 1600 |
| | 26 | | | Ti | 0.5 | 1745 | 1704 |
| | 27 | | | | 1.0 | 1647 | 1605 |
| | 28 | | | Mg | 0.5 | 1748 | 1707 |
| | 29 | | | | 1.0 | 1644 | 1602 |
| | 30 | | | Zr | 0.5 | 1744 | 1705 |
| | 31 | | | | 1.0 | 1645 | 1604 |
| | 32 | | | Al | 0.5 | 1740 | 1706 |
| | 33 | | | | 1.0 | 1647 | 1608 |
| | 34 | | | Mo | 0.5 | 1743 | 1707 |
| | 35 | | | | 1.0 | 1647 | 1608 |
| | 36 | | | W | 0.5 | 1744 | 1705 |
| | 37 | | | | 1.0 | 1650 | 1607 |
| | 38 | | | Y | 0.5 | 1745 | 1701 |
| | 39 | | | | 1.0 | 1650 | 1602 |

### <<Batteries 5C-1 to 5C-39>>

Batteries 5C-1 to 5C-39 were fabricated in the same manner as in Batteries 5A-1 to 5A-39, respectively, except that the silane coupling agent to be added to the positive electrode material mixture paste was changed to 3-methacryloxypropyltrimethoxysilane, and the intermittent cycle characteristics thereof were evaluated in the same manner. The results are shown in Table 5C.

TABLE 5C
Lithium composite oxide: LiNi_{0.34}Co_{0.33}Mn_{0.33}O₂

| | | | | | | Intermittent cycle | |
|---|---|---|---|---|---|---|---|
| | | | | | | characteristics | |
| | | | | | | Capacity after 500 | |
| | | Coupling | | | | cycles | |
| | | agent | | Element Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 5C | 1 | 3-methacryl- | 1.0 | Nil | — | 2007 | 797 |
| | 2 | oxypropyl- | | Nb | 0.5 | 2005 | 1910 |
| | 3 | trimethoxy- | | | 1.0 | 1860 | 1755 |
| | 4 | silane | | Mn | 0.5 | 2002 | 1905 |
| | 5 | | | | 1.0 | 1866 | 1757 |
| | 6 | | | Ti | 0.5 | 2005 | 1908 |
| | 7 | | | | 1.0 | 1867 | 1750 |
| | 8 | | | Mg | 0.5 | 2000 | 1907 |
| | 9 | | | | 1.0 | 1866 | 1752 |
| | 10 | | | Zr | 0.5 | 2002 | 1907 |
| | 11 | | | | 1.0 | 1870 | 1753 |
| | 12 | | | Al | 0.5 | 2005 | 1907 |
| | 13 | | | | 1.0 | 1872 | 1755 |
| | 14 | | | Mo | 0.5 | 2004 | 1908 |
| | 15 | | | | 1.0 | 1870 | 1757 |
| | 16 | | | W | 0.5 | 2003 | 1909 |
| | 17 | | | | 1.0 | 1869 | 1755 |
| | 18 | | | Y | 0.5 | 2003 | 1909 |
| | 19 | | | | 1.0 | 1867 | 1757 |
| | 21 | | 2.5 | Nil | — | 1755 | 707 |
| | 22 | | | Nb | 0.5 | 1750 | 1701 |
| | 23 | | | | 1.0 | 1657 | 1607 |
| | 24 | | | Mn | 0.5 | 1755 | 1702 |
| | 25 | | | | 1.0 | 1655 | 1607 |
| | 26 | | | Ti | 0.5 | 1757 | 1705 |
| | 27 | | | | 1.0 | 1655 | 1607 |
| | 28 | | | Mg | 0.5 | 1747 | 1704 |
| | 29 | | | | 1.0 | 1658 | 1605 |
| | 30 | | | Zr | 0.5 | 1748 | 1707 |
| | 31 | | | | 1.0 | 1655 | 1600 |
| | 32 | | | Al | 0.5 | 1757 | 1705 |
| | 33 | | | | 1.0 | 1660 | 1602 |
| | 34 | | | Mo | 0.5 | 1755 | 1707 |
| | 35 | | | | 1.0 | 1667 | 1605 |
| | 36 | | | W | 0.5 | 1757 | 1705 |
| | 37 | | | | 1.0 | 1664 | 1602 |
| | 38 | | | Y | 0.5 | 1755 | 1704 |
| | 39 | | | | 1.0 | 1660 | 1605 |

### <<Batteries 5D-1 to 5D-39>>

Batteries 5D-1 to 5D-39 were fabricated in the same manner as in Batteries 5A-1 to 5A-39, respectively, except that the silane coupling agent to be added to the positive electrode material mixture paste was changed to 3,3,3-trifluoropropyltrimethoxysilane, and the intermittent cycle characteristics thereof were evaluated in the same manner. The results are shown in Table 5D.

TABLE 5D
Lithium composite oxide: LiNi_{0.34}Co_{0.33}Mn_{0.33}O₂

| | | | | | | | Intermittent cycle | |
|---|---|---|---|---|---|---|---|---|
| | | | | | | | characteristics | |
| | | | | | | | Capacity after 500 | |
| | | | | | Element | | cycles | |
| | | | Coupling agent | | Le | | Charge rest | |
| | | | | Adding | | Adding | 30 min | 720 min |
| Battery | | | | amount | | amount | at 45° C. | at 45° C. |
| No. | | | | (wt %) | | (mol %) | (mAh) | (mAh) |
| | 5D | 1 | 3,3,3- | 1.0 | Nil | — | 2005 | 790 |
| | | 2 | trifluoro- | | Nb | 0.5 | 2004 | 1905 |
| | | 3 | propyl- | | | 1.0 | 1855 | 1750 |
| | | 4 | trimethoxy- | | Mn | 0.5 | 2003 | 1900 |
| | | 5 | silane | | | 1.0 | 1856 | 1749 |
| | | 6 | | | Ti | 0.5 | 2002 | 1902 |
| | | 7 | | | | 1.0 | 1857 | 1748 |
| | | 8 | | | Mg | 0.5 | 2000 | 1905 |
| | | 9 | | | | 1.0 | 1857 | 1744 |
| | | 10 | | | Zr | 0.5 | 2004 | 1900 |
| | | 11 | | | | 1.0 | 1855 | 1744 |
| | | 12 | | | Al | 0.5 | 2004 | 1904 |
| | | 13 | | | | 1.0 | 1850 | 1749 |
| | | 14 | | | Mo | 0.5 | 2005 | 1905 |
| | | 15 | | | | 1.0 | 1854 | 1748 |
| | | 16 | | | W | 0.5 | 2005 | 1905 |
| | | 17 | | | | 1.0 | 1850 | 1747 |
| | | 18 | | | Y | 0.5 | 2004 | 1904 |
| | | 19 | | | | 1.0 | 1852 | 1747 |
| | | 21 | | 2.5 | Nil | — | 1750 | 722 |
| | | 22 | | | Nb | 0.5 | 1740 | 1685 |
| | | 23 | | | | 1.0 | 1620 | 1600 |
| | | 24 | | | Mn | 0.5 | 1745 | 1685 |
| | | 25 | | | | 1.0 | 1625 | 1600 |
| | | 26 | | | Ti | 0.5 | 1740 | 1687 |
| | | 27 | | | | 1.0 | 1622 | 1602 |
| | | 28 | | | Mg | 0.5 | 1744 | 1687 |
| | | 29 | | | | 1.0 | 1623 | 1605 |
| | | 30 | | | Zr | 0.5 | 1743 | 1684 |
| | | 31 | | | | 1.0 | 1624 | 1604 |
| | | 32 | | | Al | 0.5 | 1744 | 1689 |
| | | 33 | | | | 1.0 | 1625 | 1604 |
| | | 34 | | | Mo | 0.5 | 1745 | 1684 |
| | | 35 | | | | 1.0 | 1625 | 1605 |
| | | 36 | | | W | 0.5 | 1742 | 1685 |
| | | 37 | | | | 1.0 | 1625 | 1605 |
| | | 38 | | | Y | 0.5 | 1744 | 1685 |
| | | 39 | | | | 1.0 | 1624 | 1605 |

### <<Batteries 5E-1 to 5E-39>>

Batteries 5E-1 to 5E-39 were fabricated in the same manner as in Batteries 5A-1 to 5A-39, respectively, except that the silane coupling agent to be added to the positive electrode material mixture paste was changed to 3,3,4,4,5,5,6,6,6-nonafluorohexyltrichlorosilane, and the intermittent cycle characteristics thereof were evaluated in the same manner. The results are shown in Table 5E.

TABLE 5E
Lithium composite oxide: LiNi_{0.34}Co_{0.33}Mn_{0.33}O₂

| | | | | | | Intermittent cycle | |
|---|---|---|---|---|---|---|---|
| | | | | | | characteristics | |
| | | | | | | Capacity after 500 | |
| | | | | Element | | cycles | |
| | | Coupling agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 5E | 1 | 3,3,4,4,5,5, | 1.0 | Nil | — | 2002 | 871 |
| | 2 | 6,6,6- | | Nb | 0.5 | 1999 | 1898 |
| | 3 | nonafluoro- | | | 1.0 | 1847 | 1750 |
| | 4 | hexyl- | | Mn | 0.5 | 1997 | 1899 |
| | 5 | trichloro- | | | 1.0 | 1845 | 1748 |
| | 6 | silane | | Ti | 0.5 | 1999 | 1900 |
| | 7 | | | | 1.0 | 1844 | 1749 |
| | 8 | | | Mg | 0.5 | 2000 | 1902 |
| | 9 | | | | 1.0 | 1844 | 1745 |
| | 10 | | | Zr | 0.5 | 2000 | 1905 |
| | 11 | | | | 1.0 | 1845 | 1748 |
| | 12 | | | Al | 0.5 | 1999 | 1899 |
| | 13 | | | | 1.0 | 1846 | 1746 |
| | 14 | | | Mo | 0.5 | 1998 | 1898 |
| | 15 | | | | 1.0 | 1847 | 1748 |
| | 16 | | | W | 0.5 | 1997 | 1897 |
| | 17 | | | | 1.0 | 1848 | 1747 |
| | 18 | | | Y | 0.5 | 1997 | 1895 |
| | 19 | | | | 1.0 | 1849 | 1747 |
| | 21 | | 2.5 | Nil | — | 1750 | 701 |
| | 22 | | | Nb | 0.5 | 1745 | 1700 |
| | 23 | | | | 1.0 | 1600 | 1600 |
| | 24 | | | Mn | 0.5 | 1748 | 1700 |
| | 25 | | | | 1.0 | 1600 | 1607 |
| | 26 | | | Ti | 0.5 | 1749 | 1703 |
| | 27 | | | | 1.0 | 1605 | 1605 |
| | 28 | | | Mg | 0.5 | 1748 | 1704 |
| | 29 | | | | 1.0 | 1608 | 1607 |
| | 30 | | | Zr | 0.5 | 1744 | 1703 |
| | 31 | | | | 1.0 | 1607 | 1601 |
| | 32 | | | Al | 0.5 | 1745 | 1705 |
| | 33 | | | | 1.0 | 1605 | 1605 |
| | 34 | | | Mo | 0.5 | 1747 | 1706 |
| | 35 | | | | 1.0 | 1607 | 1607 |
| | 36 | | | W | 0.5 | 1747 | 1707 |
| | 37 | | | | 1.0 | 1606 | 1601 |
| | 38 | | | Y | 0.5 | 1751 | 1701 |
| | 39 | | | | 1.0 | 1605 | 1604 |

### <<Batteries 5F-1 to 5F-39>>

Batteries 5F-1 to 5F-39 were fabricated in the same manner as in Batteries 5A-1 to 5A-39, respectively, except that the silane coupling agent to be added to the positive electrode material mixture paste was changed to 6-triethoxysilyl-2-norbornene, and the intermittent cycle characteristics thereof were evaluated in the same manner. The results are shown in Table 5F.

TABLE 5F
Lithium composite oxide: LiNi_{0.34}Co_{0.33}Mn_{0.33}O₂

| | | | | | | | Intermittent cycle | |
|---|---|---|---|---|---|---|---|---|
| | | | | | | | characteristics | |
| | | | | | | | Capacity after 500 | |
| | | | | | Element | | cycles | |
| | | | Coupling agent | | Le | | Charge rest | |
| | | | | Adding | | Adding | 30 min | 720 min |
| Battery | | | | amount | | amount | at 45° C. | at 45° C. |
| No. | | | | (wt %) | | (mol %) | (mAh) | (mAh) |
| | 5F | 1 | 6-triethoxy- | 1.0 | Nil | — | 2007 | 897 |
| | | 2 | silyl-2- | | Nb | 0.5 | 2000 | 1900 |
| | | 3 | norbornene | | | 1.0 | 1850 | 1752 |
| | | 4 | | | Mn | 0.5 | 2002 | 1905 |
| | | 5 | | | | 1.0 | 1840 | 1750 |
| | | 6 | | | Ti | 0.5 | 2005 | 1900 |
| | | 7 | | | | 1.0 | 1845 | 1755 |
| | | 8 | | | Mg | 0.5 | 2000 | 1905 |
| | | 9 | | | | 1.0 | 1847 | 1750 |
| | | 10 | | | Zr | 0.5 | 2005 | 1905 |
| | | 11 | | | | 1.0 | 1847 | 1752 |
| | | 12 | | | Al | 0.5 | 2000 | 1907 |
| | | 13 | | | | 1.0 | 1845 | 1752 |
| | | 14 | | | Mo | 0.5 | 2001 | 1907 |
| | | 15 | | | | 1.0 | 1847 | 1750 |
| | | 16 | | | W | 0.5 | 2003 | 1902 |
| | | 17 | | | | 1.0 | 1847 | 1750 |
| | | 18 | | | Y | 0.5 | 2002 | 1902 |
| | | 19 | | | | 1.0 | 1847 | 1755 |
| | | 21 | | 2.5 | Nil | — | 1755 | 701 |
| | | 22 | | | Nb | 0.5 | 1750 | 1700 |
| | | 23 | | | | 1.0 | 1650 | 1600 |
| | | 24 | | | Mn | 0.5 | 1751 | 1702 |
| | | 25 | | | | 1.0 | 1648 | 1605 |
| | | 26 | | | Ti | 0.5 | 1752 | 1705 |
| | | 27 | | | | 1.0 | 1649 | 1608 |
| | | 28 | | | Mg | 0.5 | 1750 | 1705 |
| | | 29 | | | | 1.0 | 1647 | 1607 |
| | | 30 | | | Zr | 0.5 | 1752 | 1700 |
| | | 31 | | | | 1.0 | 1648 | 1607 |
| | | 32 | | | Al | 0.5 | 1751 | 1705 |
| | | 33 | | | | 1.0 | 1648 | 1604 |
| | | 34 | | | Mo | 0.5 | 1750 | 1705 |
| | | 35 | | | | 1.0 | 1648 | 1604 |
| | | 36 | | | W | 0.5 | 1749 | 1700 |
| | | 37 | | | | 1.0 | 1648 | 1606 |
| | | 38 | | | Y | 0.5 | 1748 | 1700 |
| | | 39 | | | | 1.0 | 1650 | 1605 |

### <<Batteries 5R-1 to 5R-19>>

As Comparative Example, Batteries 5R-1 to 5R-19 were fabricated in the same manner as in Batteries 5A-1 to 5A-19, respectively, except that the silane coupling agent was not used, and the intermittent cycle characteristics thereof were evaluated in the same manner. The results are shown in Table 5R.

TABLE 5R
Lithium composite oxide: LiNi_{0.34}Co_{0.33}Mn_{0.33}O₂

| | | | | | | Intermittent cycle | |
|---|---|---|---|---|---|---|---|
| | | | | | | characteristics | |
| | | | | | | Capacity after 500 | |
| | | Coupling | | Element | | cycles | |
| | | agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 5R | 1 | Nil | — | Nil | — | 2010 | 809 |
| | 2 | | | Nb | 0.5 | 2002 | 802 |
| | 3 | | | | 1.0 | 1866 | 801 |
| | 4 | | | Mn | 0.5 | 2005 | 799 |
| | 5 | | | | 1.0 | 1867 | 805 |
| | 6 | | | Ti | 0.5 | 2000 | 804 |
| | 7 | | | | 1.0 | 1866 | 802 |
| | 8 | | | Mg | 0.5 | 2005 | 804 |
| | 9 | | | | 1.0 | 1869 | 806 |
| | 10 | | | Zr | 0.5 | 2005 | 802 |
| | 11 | | | | 1.0 | 1870 | 799 |
| | 12 | | | Al | 0.5 | 2007 | 798 |
| | 13 | | | | 1.0 | 1872 | 797 |
| | 14 | | | Mo | 0.5 | 2010 | 804 |
| | 15 | | | | 1.0 | 1871 | 805 |
| | 16 | | | W | 0.5 | 2008 | 807 |
| | 17 | | | | 1.0 | 1870 | 797 |
| | 18 | | | Y | 0.5 | 2009 | 799 |
| | 19 | | | | 1.0 | 1867 | 797 |

### Example 6

### Batteries 6A-1 to 6A-39

Nickel sulfate, cobalt sulfate and manganese sulfate were mixed so that the molar ratio of Ni atom, Co atom and Mn atom was 80:15:5. To 10 L of water, 3.2 kg of the mixture thus obtained was dissolved to prepare a starting material solution. To the starting material solution, 400 g of sodium hydroxide was added to form a precipitate. The precipitate was washed with water sufficiently, and then dried to yield a coprecipitated hydroxide.

To 3 kg of the Ni—Co—Mn coprecipitated hydroxide thus obtained, 784 g of lithium hydroxide was added and mixed, and then the mixture was baked for 10 hours at a synthesizing temperature of 750° C. in an atmosphere with an oxygen partial pressure of 0.5 atm. As a result, a Ni/Co based Li composite oxide containing Mn as element L (LiNi_{0.80}Co_{0.15}Mn_{0.05}O₂) was obtained.

Batteries 6A-1 to 6A-39 were fabricated using 3-mercaptopropyltrimethoxysilane in the same manner as in Batteries 1A-1 to 1A-39 of Example 1, respectively, except that the Ni/Co based Li composite oxide thus obtained was used, and the intermittent cycle characteristics thereof were evaluated in the same manner. The results are shown in Table 6A.

TABLE 6A
Lithium composite oxide: LiNi_{0.80}Co_{0.15}Mn_{0.05}O₂

| | | | | | | Intermittent cycle | |
|---|---|---|---|---|---|---|---|
| | | | | | | characteristics | |
| | | | | | | Capacity after 500 | |
| | | | | Element | | cycles | |
| | | Coupling agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 6A | 1 | 3-mercapto- | 1.0 | Nil | — | 1770 | 717 |
| | 2 | propyl- | | Nb | 0.5 | 1754 | 1719 |
| | 3 | trimethoxy- | | | 1.0 | 1721 | 1687 |
| | 4 | silane | | Mn | 0.5 | 1752 | 1717 |
| | 5 | | | | 1.0 | 1724 | 1690 |
| | 6 | | | Ti | 0.5 | 1750 | 1715 |
| | 7 | | | | 1.0 | 1725 | 1691 |
| | 8 | | | Mg | 0.5 | 1748 | 1713 |
| | 9 | | | | 1.0 | 1720 | 1686 |
| | 10 | | | Zr | 0.5 | 1749 | 1697 |
| | 11 | | | | 1.0 | 1721 | 1669 |
| | 12 | | | Al | 0.5 | 1744 | 1692 |
| | 13 | | | | 1.0 | 1722 | 1670 |
| | 14 | | | Mo | 0.5 | 1748 | 1696 |
| | 15 | | | | 1.0 | 1728 | 1676 |
| | 16 | | | W | 0.5 | 1749 | 1697 |
| | 17 | | | | 1.0 | 1729 | 1677 |
| | 18 | | | Y | 0.5 | 1745 | 1693 |
| | 19 | | | | 1.0 | 1724 | 1672 |
| | 21 | | 2.5 | Nil | — | 1735 | 697 |
| | 22 | | | Nb | 0.5 | 1722 | 1670 |
| | 23 | | | | 1.0 | 1705 | 1662 |
| | 24 | | | Mn | 0.5 | 1724 | 1681 |
| | 25 | | | | 1.0 | 1710 | 1667 |
| | 26 | | | Ti | 0.5 | 1728 | 1685 |
| | 27 | | | | 1.0 | 1708 | 1665 |
| | 28 | | | Mg | 0.5 | 1724 | 1681 |
| | 29 | | | | 1.0 | 1709 | 1658 |
| | 30 | | | Zr | 0.5 | 1726 | 1674 |
| | 31 | | | | 1.0 | 1701 | 1650 |
| | 32 | | | Al | 0.5 | 1725 | 1673 |
| | 33 | | | | 1.0 | 1705 | 1654 |
| | 34 | | | Mo | 0.5 | 1724 | 1672 |
| | 35 | | | | 1.0 | 1707 | 1656 |
| | 36 | | | W | 0.5 | 1722 | 1670 |
| | 37 | | | | 1.0 | 1709 | 1658 |
| | 38 | | | Y | 0.5 | 1721 | 1669 |
| | 39 | | | | 1.0 | 1708 | 1657 |

### <<Batteries 6B-1 to 6B-39>>

Batteries 6B-1 to 6B-39 were fabricated in the same manner as in Batteries 6A-1 to 6A-39, respectively, except that the silane coupling agent to be added to the positive electrode material mixture paste was changed to hexyltrimethoxysilane, and the intermittent cycle characteristics thereof were evaluated in the same manner. The results are shown in Table 6B.

TABLE 6B
Lithium composite oxide: LiNi_{0.80}Co_{0.15}Mn_{0.05}O₂

| | | | | | | Intermittent cycle | |
|---|---|---|---|---|---|---|---|
| | | | | | | characteristics | |
| | | | | | | Capacity after 500 | |
| | | | | Element | | cycles | |
| | | Coupling agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 6B | 1 | Hexyl- | 1.0 | Nil | — | 1760 | 711 |
| | 2 | trimethoxy- | | Nb | 0.5 | 1755 | 1711 |
| | 3 | silane | | | 1.0 | 1720 | 1677 |
| | 4 | | | Mn | 0.5 | 1751 | 1707 |
| | 5 | | | | 1.0 | 1721 | 1678 |
| | 6 | | | Ti | 0.5 | 1752 | 1708 |
| | 7 | | | | 1.0 | 1725 | 1682 |
| | 8 | | | Mg | 0.5 | 1755 | 1711 |
| | 9 | | | | 1.0 | 1720 | 1677 |
| | 10 | | | Zr | 0.5 | 1754 | 1710 |
| | 11 | | | | 1.0 | 1724 | 1681 |
| | 12 | | | Al | 0.5 | 1750 | 1706 |
| | 13 | | | | 1.0 | 1725 | 1682 |
| | 14 | | | Mo | 0.5 | 1752 | 1708 |
| | 15 | | | | 1.0 | 1720 | 1668 |
| | 16 | | | W | 0.5 | 1754 | 1701 |
| | 17 | | | | 1.0 | 1721 | 1669 |
| | 18 | | | Y | 0.5 | 1752 | 1699 |
| | 19 | | | | 1.0 | 1724 | 1672 |
| | 21 | | 2.5 | Nil | — | 1751 | 671 |
| | 22 | | | Nb | 0.5 | 1729 | 1677 |
| | 23 | | | | 1.0 | 1705 | 1671 |
| | 24 | | | Mn | 0.5 | 1747 | 1712 |
| | 25 | | | | 1.0 | 1704 | 1670 |
| | 26 | | | Ti | 0.5 | 1745 | 1710 |
| | 27 | | | | 1.0 | 1702 | 1668 |
| | 28 | | | Mg | 0.5 | 1748 | 1713 |
| | 29 | | | | 1.0 | 1705 | 1671 |
| | 30 | | | Zr | 0.5 | 1744 | 1709 |
| | 31 | | | | 1.0 | 1704 | 1653 |
| | 32 | | | Al | 0.5 | 1740 | 1688 |
| | 33 | | | | 1.0 | 1702 | 1651 |
| | 34 | | | Mo | 0.5 | 1743 | 1691 |
| | 35 | | | | 1.0 | 1701 | 1650 |
| | 36 | | | W | 0.5 | 1744 | 1692 |
| | 37 | | | | 1.0 | 1709 | 1658 |
| | 38 | | | Y | 0.5 | 1745 | 1693 |
| | 39 | | | | 1.0 | 1701 | 1650 |

### <<Batteries 6C-1 to 6C-39>>

Batteries 6C-1 to 6C-39 were fabricated in the same manner as in Batteries 6A-1 to 6A-39, respectively, except that the silane coupling agent to be added to the positive electrode material mixture paste was changed to 3-methacryloxypropyltrimethoxysilane, and the intermittent cycle characteristics thereof were evaluated in the same manner. The results are shown in Table 6C.

TABLE 6C
Lithium composite oxide: LiNi_{0.80}Co_{0.15}Mn_{0.05}O₂

| | | | | | | Intermittent cycle | |
|---|---|---|---|---|---|---|---|
| | | | | | | characteristics | |
| | | | | | | Capacity after 500 | |
| | | | | Element | | cycles | |
| | | Coupling agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 6C | 1 | 3-methacryl- | 1.0 | Nil | — | 1760 | 697 |
| | 2 | oxypropyl- | | Nb | 0.5 | 1752 | 1699 |
| | 3 | trimethoxy- | | | 1.0 | 1722 | 1670 |
| | 4 | silane | | Mn | 0.5 | 1751 | 1698 |
| | 5 | | | | 1.0 | 1724 | 1672 |
| | 6 | | | Ti | 0.5 | 1755 | 1702 |
| | 7 | | | | 1.0 | 1724 | 1672 |
| | 8 | | | Mg | 0.5 | 1752 | 1699 |
| | 9 | | | | 1.0 | 1722 | 1670 |
| | 10 | | | Zr | 0.5 | 1755 | 1702 |
| | 11 | | | | 1.0 | 1724 | 1672 |
| | 12 | | | Al | 0.5 | 1754 | 1701 |
| | 13 | | | | 1.0 | 1727 | 1684 |
| | 14 | | | Mo | 0.5 | 1758 | 1714 |
| | 15 | | | | 1.0 | 1722 | 1679 |
| | 16 | | | W | 0.5 | 1752 | 1708 |
| | 17 | | | | 1.0 | 1724 | 1681 |
| | 18 | | | Y | 0.5 | 1757 | 1713 |
| | 19 | | | | 1.0 | 1723 | 1680 |
| | 21 | | 2.5 | Nil | — | 1720 | 677 |
| | 22 | | | Nb | 0.5 | 1722 | 1679 |
| | 23 | | | | 1.0 | 1702 | 1659 |
| | 24 | | | Mn | 0.5 | 1724 | 1681 |
| | 25 | | | | 1.0 | 1705 | 1662 |
| | 26 | | | Ti | 0.5 | 1728 | 1693 |
| | 27 | | | | 1.0 | 1704 | 1670 |
| | 28 | | | Mg | 0.5 | 1725 | 1691 |
| | 29 | | | | 1.0 | 1707 | 1673 |
| | 30 | | | Zr | 0.5 | 1724 | 1690 |
| | 31 | | | | 1.0 | 1706 | 1672 |
| | 32 | | | Al | 0.5 | 1722 | 1688 |
| | 33 | | | | 1.0 | 1708 | 1674 |
| | 34 | | | Mo | 0.5 | 1726 | 1691 |
| | 35 | | | | 1.0 | 1704 | 1670 |
| | 36 | | | W | 0.5 | 1725 | 1691 |
| | 37 | | | | 1.0 | 1705 | 1671 |
| | 38 | | | Y | 0.5 | 1727 | 1692 |
| | 39 | | | | 1.0 | 1702 | 1668 |

### <<Batteries 6R-1 to 6R-19>>

As Comparative Example, Batteries 6R-1 to 6R-19 were fabricated in the same manner as in Batteries 6A-1 to 6A-19, respectively, except that the silane coupling agent was not used, and the intermittent cycle characteristics thereof were evaluated in the same manner. The results are shown in Table 6R.

TABLE 6R
Lithium composite oxide: LiNi_{0.80}Co_{0.15}Mn_{0.05}O₂

| | | | | | | Intermittent cycle | |
|---|---|---|---|---|---|---|---|
| | | | | | | characteristics | |
| | | | | | | Capacity after 500 | |
| | | Coupling | | Element | | cycles | |
| | | agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 6R | 1 | Nil | — | Nil | — | 1750 | 570 |
| | 2 | | | Nb | 0.5 | 1752 | 581 |
| | 3 | | | | 1.0 | 1720 | 540 |
| | 4 | | | Mn | 0.5 | 1754 | 582 |
| | 5 | | | | 1.0 | 1725 | 542 |
| | 6 | | | Ti | 0.5 | 1752 | 585 |
| | 7 | | | | 1.0 | 1720 | 541 |
| | 8 | | | Mg | 0.5 | 1754 | 584 |
| | 9 | | | | 1.0 | 1721 | 547 |
| | 10 | | | Zr | 0.5 | 1750 | 584 |
| | 11 | | | | 1.0 | 1724 | 543 |
| | 12 | | | Al | 0.5 | 1754 | 587 |
| | 13 | | | | 1.0 | 1720 | 542 |
| | 14 | | | Mo | 0.5 | 1752 | 589 |
| | 15 | | | | 1.0 | 1724 | 540 |
| | 16 | | | W | 0.5 | 1754 | 587 |
| | 17 | | | | 1.0 | 1725 | 541 |
| | 18 | | | Y | 0.5 | 1754 | 586 |
| | 19 | | | | 1.0 | 1728 | 548 |

### Example 7

### Batteries 7A-1 to 7A-39

Nickel sulfate and cobalt sulfate were mixed so that the molar ratio of Ni atom and Co atom was 75:25. To 10 L of water, 3.2 kg of the mixture thus obtained was dissolved to prepare a starting material solution. To the starting material solution, 400 g of sodium hydroxide was added to form a precipitate. The precipitate was washed with water sufficiently, and then dried to yield a coprecipitated hydroxide.

To 3 kg of the Ni—Co coprecipitated hydroxide thus obtained, 784 g of lithium hydroxide was added and mixed, and then the mixture was baked for 10 hours at a synthesizing temperature of 750° C. in an atmosphere with an oxygen partial pressure of 0.5 atm. As a result, a Ni/Co based Li composite oxide not containing element L (LiNi_{0.75}Co_{0.25}O₂) was obtained.

Batteries 7A-1 to 7A-39 were fabricated using 3-mercaptopropyltrimethoxysilane in the same manner as in Batteries 1A-1 to 1A-39 of Example 1, respectively, except that the Ni/Co based Li composite oxide not containing element L thus obtained was used, and the intermittent cycle characteristics thereof were evaluated in the same manner. The results are shown in Table 7A.

TABLE 7A
Lithium composite oxide: LiNi_{0.75}Co_{0.25}O₂

| | | | | | | Intermittent cycle | |
|---|---|---|---|---|---|---|---|
| | | | | | | characteristics | |
| | | | | | | Capacity after 500 | |
| | | | | Element | | cycles | |
| | | Coupling agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 7A | 1 | 3-mercapto- | 1.0 | Nil | — | 2188 | 710 |
| | 2 | propyl- | | Nb | 0.5 | 2188 | 2180 |
| | 3 | trimethoxy- | | | 1.0 | 2020 | 2008 |
| | 4 | silane | | Mn | 0.5 | 2185 | 2182 |
| | 5 | | | | 1.0 | 2022 | 2005 |
| | 6 | | | Ti | 0.5 | 2184 | 2187 |
| | 7 | | | | 1.0 | 2025 | 2004 |
| | 8 | | | Mg | 0.5 | 2187 | 2185 |
| | 9 | | | | 1.0 | 2027 | 2002 |
| | 10 | | | Zr | 0.5 | 2185 | 2181 |
| | 11 | | | | 1.0 | 2027 | 2001 |
| | 12 | | | Al | 0.5 | 2184 | 2187 |
| | 13 | | | | 1.0 | 2025 | 2002 |
| | 14 | | | Mo | 0.5 | 2182 | 2181 |
| | 15 | | | | 1.0 | 2027 | 2005 |
| | 16 | | | W | 0.5 | 2180 | 2180 |
| | 17 | | | | 1.0 | 2027 | 2002 |
| | 18 | | | Y | 0.5 | 2188 | 2187 |
| | 19 | | | | 1.0 | 2021 | 2000 |
| | 21 | | 2.5 | Nil | — | 2007 | 692 |
| | 22 | | | Nb | 0.5 | 2002 | 1920 |
| | 23 | | | | 1.0 | 1907 | 1815 |
| | 24 | | | Mn | 0.5 | 2005 | 1922 |
| | 25 | | | | 1.0 | 1905 | 1817 |
| | 26 | | | Ti | 0.5 | 2004 | 1921 |
| | 27 | | | | 1.0 | 1902 | 1812 |
| | 28 | | | Mg | 0.5 | 2006 | 1925 |
| | 29 | | | | 1.0 | 1900 | 1810 |
| | 30 | | | Zr | 0.5 | 2003 | 1927 |
| | 31 | | | | 1.0 | 1905 | 1817 |
| | 32 | | | Al | 0.5 | 2002 | 1923 |
| | 33 | | | | 1.0 | 1902 | 1815 |
| | 34 | | | Mo | 0.5 | 2007 | 1924 |
| | 35 | | | | 1.0 | 1901 | 1812 |
| | 36 | | | W | 0.5 | 2001 | 1925 |
| | 37 | | | | 1.0 | 1905 | 1817 |
| | 38 | | | Y | 0.5 | 2003 | 1927 |
| | 39 | | | | 1.0 | 1904 | 1817 |

### <<Batteries 7B-1 to 7B-39>>

Batteries 7B-1 to 7B-39 were fabricated in the same manner as in Batteries 7A-1 to 7A-39, respectively, except that the silane coupling agent to be added to the positive electrode material mixture paste was changed to hexyltrimethoxysilane, and the intermittent cycle characteristics thereof were evaluated in the same manner. The results are shown in Table 7B.

TABLE 7B
Lithium composite oxide: LiNi_{0.75}Co_{0.25}O₂

| | | | | | | Intermittent cycle | |
|---|---|---|---|---|---|---|---|
| | | | | | | characteristics | |
| | | | | | | Capacity after 500 | |
| | | | | Element | | cycles | |
| | | Coupling agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 7B | 1 | Hexyl- | 1.0 | Nil | — | 2190 | 715 |
| | 2 | trimethoxy- | | Nb | 0.5 | 2187 | 2155 |
| | 3 | silane | | | 1.0 | 2015 | 2004 |
| | 4 | | | Mn | 0.5 | 2185 | 2160 |
| | 5 | | | | 1.0 | 2012 | 2002 |
| | 6 | | | Ti | 0.5 | 2184 | 2154 |
| | 7 | | | | 1.0 | 2010 | 2000 |
| | 8 | | | Mg | 0.5 | 2182 | 2155 |
| | 9 | | | | 1.0 | 2015 | 2001 |
| | 10 | | | Zr | 0.5 | 2188 | 2154 |
| | 11 | | | | 1.0 | 2010 | 2002 |
| | 12 | | | Al | 0.5 | 2187 | 2157 |
| | 13 | | | | 1.0 | 2012 | 2005 |
| | 14 | | | Mo | 0.5 | 2189 | 2155 |
| | 15 | | | | 1.0 | 2012 | 2004 |
| | 16 | | | W | 0.5 | 2188 | 2158 |
| | 17 | | | | 1.0 | 2010 | 2003 |
| | 18 | | | Y | 0.5 | 2185 | 2154 |
| | 19 | | | | 1.0 | 2011 | 2003 |
| | 21 | | 2.5 | Nil | — | 2000 | 620 |
| | 22 | | | Nb | 0.5 | 2002 | 1905 |
| | 23 | | | | 1.0 | 1900 | 1801 |
| | 24 | | | Mn | 0.5 | 2005 | 1902 |
| | 25 | | | | 1.0 | 1905 | 1802 |
| | 26 | | | Ti | 0.5 | 2007 | 1901 |
| | 27 | | | | 1.0 | 1907 | 1805 |
| | 28 | | | Mg | 0.5 | 2005 | 1907 |
| | 29 | | | | 1.0 | 1905 | 1804 |
| | 30 | | | Zr | 0.5 | 2007 | 1902 |
| | 31 | | | | 1.0 | 1907 | 1804 |
| | 32 | | | Al | 0.5 | 2001 | 1905 |
| | 33 | | | | 1.0 | 1904 | 1802 |
| | 34 | | | Mo | 0.5 | 2005 | 1907 |
| | 35 | | | | 1.0 | 1902 | 1800 |
| | 36 | | | W | 0.5 | 2008 | 1905 |
| | 37 | | | | 1.0 | 1904 | 1807 |
| | 38 | | | Y | 0.5 | 2001 | 1900 |
| | 39 | | | | 1.0 | 1902 | 1807 |

### <<Batteries 7C-1 to 7C-39>>

Batteries 7C-1 to 7C-39 were fabricated in the same manner as in Batteries 7A-1 to 7A-39, respectively, except that the silane coupling agent to be added to the positive electrode material mixture paste was changed to 3-methacryloxypropyltrimethoxysilane, and the intermittent cycle characteristics thereof were evaluated in the same manner. The results are shown in Table 7C.

TABLE 7C
Lithium composite oxide: LiNi_{0.75}Co_{0.25}O₂

| | | | | | | Intermittent cycle | |
|---|---|---|---|---|---|---|---|
| | | | | | | characteristics | |
| | | | | | | Capacity after 500 | |
| | | | | Element | | cycles | |
| | | Coupling agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 7C | 1 | 3-methacryl- | 1.0 | Nil | — | 2192 | 740 |
| | 2 | oxypropyl- | | Nb | 0.5 | 2188 | 2145 |
| | 3 | trimethoxy- | | | 1.0 | 2012 | 2004 |
| | 4 | silane | | Mn | 0.5 | 2180 | 2140 |
| | 5 | | | | 1.0 | 2017 | 2005 |
| | 6 | | | Ti | 0.5 | 2185 | 2144 |
| | 7 | | | | 1.0 | 2012 | 2007 |
| | 8 | | | Mg | 0.5 | 2182 | 2142 |
| | 9 | | | | 1.0 | 2010 | 2002 |
| | 10 | | | Zr | 0.5 | 2187 | 2147 |
| | 11 | | | | 1.0 | 2017 | 2000 |
| | 12 | | | Al | 0.5 | 2187 | 2145 |
| | 13 | | | | 1.0 | 2015 | 2007 |
| | 14 | | | Mo | 0.5 | 2185 | 2144 |
| | 15 | | | | 1.0 | 2017 | 2005 |
| | 16 | | | W | 0.5 | 2181 | 2142 |
| | 17 | | | | 1.0 | 2015 | 2002 |
| | 18 | | | Y | 0.5 | 2187 | 2147 |
| | 19 | | | | 1.0 | 2011 | 2007 |
| | 21 | | 2.5 | Nil | — | 2007 | 627 |
| | 22 | | | Nb | 0.5 | 2005 | 1910 |
| | 23 | | | | 1.0 | 1908 | 1805 |
| | 24 | | | Mn | 0.5 | 2002 | 1908 |
| | 25 | | | | 1.0 | 1905 | 1802 |
| | 26 | | | Ti | 0.5 | 2005 | 1907 |
| | 27 | | | | 1.0 | 1907 | 1800 |
| | 28 | | | Mg | 0.5 | 2004 | 1911 |
| | 29 | | | | 1.0 | 1901 | 1805 |
| | 30 | | | Zr | 0.5 | 2003 | 1907 |
| | 31 | | | | 1.0 | 1905 | 1807 |
| | 32 | | | Al | 0.5 | 2004 | 1908 |
| | 33 | | | | 1.0 | 1907 | 1807 |
| | 34 | | | Mo | 0.5 | 2005 | 1909 |
| | 35 | | | | 1.0 | 1905 | 1805 |
| | 36 | | | W | 0.5 | 2002 | 1912 |
| | 37 | | | | 1.0 | 1902 | 1800 |
| | 38 | | | Y | 0.5 | 2001 | 1911 |
| | 39 | | | | 1.0 | 1904 | 1801 |

### <<Batteries 7D-1 to 7D-39>>

Batteries 7D-1 to 7D-39 were fabricated in the same manner as in Batteries 7A-1 to 7A-39, respectively, except that the silane coupling agent to be added to the positive electrode material mixture paste was changed to 3,3,3-trifluoropropyltrimethoxysilane, and the intermittent cycle characteristics thereof were evaluated in the same manner. The results are shown in Table 7D.

TABLE 7D
Lithium composite oxide: LiNi_{0.75}Co_{0.25}O₂

| | | | | | | | Intermittent cycle | |
|---|---|---|---|---|---|---|---|---|
| | | | | | | | characteristics | |
| | | | | | | | Capacity after 500 | |
| | | | | | Element | | cycles | |
| | | | Coupling agent | | Le | | Charge rest | |
| | | | | Adding | | Adding | 30 min | 720 min |
| Battery | | | | amount | | amount | at 45° C. | at 45° C. |
| No. | | | | (wt %) | | (mol %) | (mAh) | (mAh) |
| | 7D | 1 | 3,3,3- | 1.0 | Nil | — | 2187 | 725 |
| | | 2 | trifluoro- | | Nb | 0.5 | 2177 | 2100 |
| | | 3 | propyl- | | | 1.0 | 2010 | 2005 |
| | | 4 | trimethoxy- | | Mn | 0.5 | 2175 | 2105 |
| | | 5 | silane | | | 1.0 | 2011 | 2002 |
| | | 6 | | | Ti | 0.5 | 2174 | 2104 |
| | | 7 | | | | 1.0 | 2009 | 2000 |
| | | 8 | | | Mg | 0.5 | 2175 | 2103 |
| | | 9 | | | | 1.0 | 2012 | 2001 |
| | | 10 | | | Zr | 0.5 | 2177 | 2102 |
| | | 11 | | | | 1.0 | 2011 | 2000 |
| | | 12 | | | Al | 0.5 | 2171 | 2100 |
| | | 13 | | | | 1.0 | 2015 | 2005 |
| | | 14 | | | Mo | 0.5 | 2172 | 2101 |
| | | 15 | | | | 1.0 | 2013 | 2004 |
| | | 16 | | | W | 0.5 | 2172 | 2107 |
| | | 17 | | | | 1.0 | 2010 | 2002 |
| | | 18 | | | Y | 0.5 | 2177 | 2107 |
| | | 19 | | | | 1.0 | 2008 | 2000 |
| | | 21 | | 2.5 | Nil | — | 2007 | 711 |
| | | 22 | | | Nb | 0.5 | 2002 | 1908 |
| | | 23 | | | | 1.0 | 1905 | 1802 |
| | | 24 | | | Mn | 0.5 | 2001 | 1902 |
| | | 25 | | | | 1.0 | 1904 | 1800 |
| | | 26 | | | Ti | 0.5 | 2004 | 1905 |
| | | 27 | | | | 1.0 | 1902 | 1800 |
| | | 28 | | | Mg | 0.5 | 2000 | 1904 |
| | | 29 | | | | 1.0 | 1900 | 1807 |
| | | 30 | | | Zr | 0.5 | 2001 | 1905 |
| | | 31 | | | | 1.0 | 1907 | 1804 |
| | | 32 | | | Al | 0.5 | 2005 | 1904 |
| | | 33 | | | | 1.0 | 1905 | 1805 |
| | | 34 | | | Mo | 0.5 | 2001 | 1908 |
| | | 35 | | | | 1.0 | 1900 | 1802 |
| | | 36 | | | W | 0.5 | 2004 | 1902 |
| | | 37 | | | | 1.0 | 1907 | 1804 |
| | | 38 | | | Y | 0.5 | 2000 | 1900 |
| | | 39 | | | | 1.0 | 1905 | 1802 |

### <<Batteries 7E-1 to 7E-39>>

Batteries 7E-1 to 7E-39 were fabricated in the same manner as in Batteries 7A-1 to 7A-39, respectively, except that the silane coupling agent to be added to the positive electrode material mixture paste was changed to 3,3,4,4,5,5,6,6,6-nonafluorohexyltrichlorosilane, and the intermittent cycle characteristics thereof were evaluated in the same manner. The results are shown in Table 7E.

TABLE 7E
Lithium composite oxide: LiNi_{0.75}Co_{0.25}O₂

| | | | | | | Intermittent cycle | |
|---|---|---|---|---|---|---|---|
| | | | | | | characteristics | |
| | | | | | | Capacity after 500 | |
| | | | | Element | | cycles | |
| | | Coupling agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 7E | 1 | 3,3,4,4,5,5, | 1.0 | Nil | — | 2188 | 712 |
| | 2 | 6,6,6- | | Nb | 0.5 | 2180 | 2155 |
| | 3 | nonafluoro- | | | 1.0 | 2017 | 2004 |
| | 4 | hexyl- | | Mn | 0.5 | 2182 | 2156 |
| | 5 | trichloro- | | | 1.0 | 2015 | 2007 |
| | 6 | silane | | Ti | 0.5 | 2188 | 2155 |
| | 7 | | | | 1.0 | 2012 | 2008 |
| | 8 | | | Mg | 0.5 | 2187 | 2157 |
| | 9 | | | | 1.0 | 2011 | 2000 |
| | 10 | | | Zr | 0.5 | 2185 | 2154 |
| | 11 | | | | 1.0 | 2011 | 2000 |
| | 12 | | | Al | 0.5 | 2184 | 2152 |
| | 13 | | | | 1.0 | 2017 | 2002 |
| | 14 | | | Mo | 0.5 | 2185 | 2150 |
| | 15 | | | | 1.0 | 2015 | 2003 |
| | 16 | | | W | 0.5 | 2187 | 2155 |
| | 17 | | | | 1.0 | 2011 | 2007 |
| | 18 | | | Y | 0.5 | 2188 | 2157 |
| | 19 | | | | 1.0 | 2014 | 2005 |
| | 21 | | 2.5 | Nil | — | 2003 | 671 |
| | 22 | | | Nb | 0.5 | 2000 | 1902 |
| | 23 | | | | 1.0 | 1900 | 1801 |
| | 24 | | | Mn | 0.5 | 2002 | 1901 |
| | 25 | | | | 1.0 | 1902 | 1802 |
| | 26 | | | Ti | 0.5 | 2001 | 1902 |
| | 27 | | | | 1.0 | 1901 | 1800 |
| | 28 | | | Mg | 0.5 | 2001 | 1905 |
| | 29 | | | | 1.0 | 1905 | 1800 |
| | 30 | | | Zr | 0.5 | 2002 | 1908 |
| | 31 | | | | 1.0 | 1904 | 1802 |
| | 32 | | | Al | 0.5 | 2004 | 1907 |
| | 33 | | | | 1.0 | 1903 | 1810 |
| | 34 | | | Mo | 0.5 | 2003 | 1908 |
| | 35 | | | | 1.0 | 1902 | 1809 |
| | 36 | | | W | 0.5 | 2002 | 1905 |
| | 37 | | | | 1.0 | 1900 | 1807 |
| | 38 | | | Y | 0.5 | 2003 | 1904 |
| | 39 | | | | 1.0 | 1900 | 1805 |

### <<Batteries 7F-1 to 7F-39>>

Batteries 7F-1 to 7F-39 were fabricated in the same manner as in Batteries 7A-1 to 7A-39, respectively, except that the silane coupling agent to be added to the positive electrode material mixture paste was changed to 6-triethoxysilyl-2-norbornene, and the intermittent cycle characteristics thereof were evaluated in the same manner. The results are shown in Table 7F.

TABLE 7F
Lithium composite oxide: LiNi_{0.75}Co_{0.25}O₂

| | | | | | | Intermittent cycle | |
|---|---|---|---|---|---|---|---|
| | | | | | | characteristics | |
| | | | | | | Capacity after 500 | |
| | | Coupling | | Element | | cycles | |
| | | agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 7F | 1 | 6-triethoxy- | 1.0 | Nil | — | 2187 | 717 |
| | 2 | silyl-2- | | Nb | 0.5 | 2187 | 2150 |
| | 3 | norbornene | | | 1.0 | 2015 | 2000 |
| | 4 | | | Mn | 0.5 | 2188 | 2155 |
| | 5 | | | | 1.0 | 2020 | 2002 |
| | 6 | | | Ti | 0.5 | 2189 | 2157 |
| | 7 | | | | 1.0 | 2022 | 2005 |
| | 8 | | | Mg | 0.5 | 2187 | 2155 |
| | 9 | | | | 1.0 | 2018 | 2004 |
| | 10 | | | Zr | 0.5 | 2185 | 2155 |
| | 11 | | | | 1.0 | 2017 | 2005 |
| | 12 | | | Al | 0.5 | 2189 | 2150 |
| | 13 | | | | 1.0 | 2020 | 2004 |
| | 14 | | | Mo | 0.5 | 2188 | 2152 |
| | 15 | | | | 1.0 | 2019 | 2005 |
| | 16 | | | W | 0.5 | 2190 | 2154 |
| | 17 | | | | 1.0 | 2017 | 2000 |
| | 18 | | | Y | 0.5 | 2192 | 2150 |
| | 19 | | | | 1.0 | 2018 | 2000 |
| | 21 | | 2.5 | Nil | — | 2002 | 657 |
| | 22 | | | Nb | 0.5 | 2005 | 1910 |
| | 23 | | | | 1.0 | 1908 | 1805 |
| | 24 | | | Mn | 0.5 | 2004 | 1912 |
| | 25 | | | | 1.0 | 1905 | 1802 |
| | 26 | | | Ti | 0.5 | 2000 | 1907 |
| | 27 | | | | 1.0 | 1904 | 1800 |
| | 28 | | | Mg | 0.5 | 2005 | 1907 |
| | 29 | | | | 1.0 | 1907 | 1805 |
| | 30 | | | Zr | 0.5 | 2007 | 1907 |
| | 31 | | | | 1.0 | 1905 | 1807 |
| | 32 | | | Al | 0.5 | 2005 | 1905 |
| | 33 | | | | 1.0 | 1907 | 1805 |
| | 34 | | | Mo | 0.5 | 2000 | 1907 |
| | 35 | | | | 1.0 | 1908 | 1804 |
| | 36 | | | W | 0.5 | 2002 | 1910 |
| | 37 | | | | 1.0 | 1909 | 1802 |
| | 38 | | | Y | 0.5 | 2003 | 1917 |
| | 39 | | | | 1.0 | 1907 | 1809 |

### <<Batteries 7R-1 to 7R-19>>

As Comparative Example, Batteries 7R-1 to 7R-19 were fabricated in the same manner as in Batteries 7A-1 to 7A-19, respectively, except that the silane coupling agent was not used, and the intermittent cycle characteristics thereof were evaluated in the same manner. The results are shown in Table 7R.

TABLE 7R
Lithium composite oxide: LiNi_{0.75}Co_{0.25}O₂

| | | | | | | Intermittent cycle | |
|---|---|---|---|---|---|---|---|
| | | | | | | characteristics | |
| | | | | | | Capacity after 500 | |
| | | Coupling | | Element | | cycles | |
| | | agent | | Le | | Charge rest | |
| | | | Adding | | Adding | 30 min | 720 min |
| Battery | | | amount | | amount | at 45° C. | at 45° C. |
| No. | | | (wt %) | | (mol %) | (mAh) | (mAh) |
| 7R | 1 | Nil | — | Nil | — | 2188 | 712 |
| | 2 | | | Nb | 0.5 | 2187 | 812 |
| | 3 | | | | 1.0 | 2020 | 817 |
| | 4 | | | Mn | 0.5 | 2187 | 810 |
| | 5 | | | | 1.0 | 2015 | 823 |
| | 6 | | | Ti | 0.5 | 2187 | 824 |
| | 7 | | | | 1.0 | 2017 | 825 |
| | 8 | | | Mg | 0.5 | 2178 | 845 |
| | 9 | | | | 1.0 | 2020 | 814 |
| | 10 | | | Zr | 0.5 | 2179 | 810 |
| | 11 | | | | 1.0 | 2022 | 826 |
| | 12 | | | Al | 0.5 | 2175 | 825 |
| | 13 | | | | 1.0 | 2025 | 822 |
| | 14 | | | Mo | 0.5 | 2180 | 823 |
| | 15 | | | | 1.0 | 2027 | 822 |
| | 16 | | | W | 0.5 | 2182 | 820 |
| | 17 | | | | 1.0 | 2021 | 825 |
| | 18 | | | Y | 0.5 | 2187 | 827 |
| | 19 | | | | 1.0 | 2020 | 827 |

In the subsequent Examples, evaluations were performed with respect to lithium composite oxides synthesized using various starting materials in place of the above-described Ni/Co based Li composite oxides; however, the description of these is omitted.

### INDUSTRIAL APPLICABILITY

The present invention is useful in a lithium ion secondary battery including, as a positive electrode active material, a lithium composite oxide mainly composed of nickel or cobalt. According to the present invention, the cycle characteristics under the conditions more similar to the conditions in practical use of lithium ion secondary batteries (for example, intermittent cycles) can be more improved than before without impairing the ability of suppressing gas generation or heat generation due to internal short-circuit.

The shape of the lithium ion secondary battery of the present invention is not particularly limited, and the battery may be of any shape, for example, a coin shape, a button shape, a sheet shape, a cylindrical shape, a flat shape, a rectangular shape and the like. As for the form of the electrode assembly comprising a positive electrode, a negative electrode and a separator, it may be a wound type or a stacked type. As for the size of the battery, it may be a small size for use in small portable devices etc. or a large size for use in electric cars etc. The lithium ion secondary battery of the present invention is applicable, for example, as a power supply for personal digital assistants, portable electronic devices, compact home electrical energy storage devices, motorcycles, electric cars, hybrid electric cars and the like. However, the applications thereof are not particularly limited.

1. A lithium ion secondary battery having a chargeable and dischargeable positive electrode, a chargeable and dischargeable negative electrode, and a non-aqueous electrolyte, wherein
said positive electrode includes active material particles,
said active material particles include a lithium composite oxide,
said lithium composite oxide is represented by the general formula (1): LiₓM_{1-y}L_{y}O₂, the general formula (1) satisfies 0.85≦x≦1.25 and 0≦y≦0.50,
element M is at least one selected from the group consisting of Ni and Co,
element L is at least one selected from the group consisting of alkaline earth elements, transition metal elements, rare earth elements, Group IIIb elements and Group IVb elements,
the surface layer of said active material particles includes element Le being at least one selected from the group consisting of Mn, Ti, Zr, Nb, Mo, W and Y, and
said active material particles are surface-treated with a coupling agent.

2. The lithium ion secondary battery in accordance with claim 1, wherein in the general formula (1), 0<y, and element L includes at least one selected from the group consisting of Al, Mn, Ti, Mg, Zr, Nb, Mo, W and Y as an essential element.

3. The lithium ion secondary battery in accordance with claim 1, wherein element L and element Le form crystalline structures different from each other.

4. The lithium ion secondary battery in accordance with claim 1, wherein element Le forms an oxide having a crystalline structure different from that of said lithium composite oxide.

5. The lithium ion secondary battery in accordance with claim 1, wherein an amount of said coupling agent is less than or equal to 2 parts by weight relative to 100 parts by weight of said active material particles.

6. The lithium ion secondary battery in accordance with claim 1, wherein said coupling agent is a silane coupling agent.

7. The lithium ion secondary battery in accordance with claim 6, wherein said silane coupling agent includes at least one selected from the group consisting of an alkoxide group and a chlorine atom, and at least one selected from the group consisting of a mercapto group, an alkyl group and a fluorine atom.

8. The lithium ion secondary battery in accordance with claim 6, wherein said silane coupling agent forms a silicon compound bonded to the surface of said active material particles through Si—O bonds.

9. The lithium ion secondary battery in accordance with claim 1, wherein a mean particle size of said active material particles is more than or equal to 10 μm.

10. The lithium ion secondary battery in accordance with claim 1, wherein said non-aqueous electrolyte includes at least one selected from the group consisting of vinylene carbonate, vinyl ethylene carbonate, phosphazene and fluorobenzene.
